(19) United States
(12) Patent Application Publication
(10) Pub. No.: US 2013/0087503 A1
(43) Pub. Date: Apr. 11, 2013

(54) LOW-ENERGY SYSTEM FOR COLLECTING MATTER

(71) Applicants: Ross O. Youngs, Dublin, OH (US); James R. Cook, Dublin, OH (US); Shanon I. Rogers, Fremont, OH (US)

(72) Inventors: Ross O. Youngs, Dublin, OH (US); James R. Cook, Dublin, OH (US); Shanon I. Rogers, Fremont, OH (US)

(73) Assignee: Algaeventure Systems, Inc., Marysville, OH (US)

(21) Appl. No.: 13/704,912

(22) PCT Filed: Jun. 17, 2011
(86) PCT No.: PCT/US2011/040804

§ 371 Date: Dec. 17, 2012

Related U.S. Application Data
(60) Provisional application No. 61/355,969, filed on Jun. 17, 2010.
(60) Provisional application No. 61/355,990, filed on Jun. 17, 2010.

(51) Int. Cl. B01D 15/00

(52) U.S. Cl. CPC B01D 15/00
USPC 210/660; 210/500.1

(57) ABSTRACT

A system for collecting matter provides a low energy, low cost and nearly zero pollutant process for extracting suspended and/or dissolved matter in a medium. The system collects the matter on a material which is deployed into the medium, and the matter is extracted off the material. If the extracted matter is algae, then it can be processed into end user commercial products such as pharmaceuticals, nutraceuticals, cosmetics, biofuels, food products, crop fertilizer, animal feed and polymers. If the extracted matter is oil or bitumen, then it can be recovered at oil spills or in tar sands. If the medium is infected with a harmful algae bloom of cyanobacteria, then the system could not only harvest the algae for processing but also cut off a food source of remaining algae by additionally extracting suspended silt. This invention collects matter in an economically and environmentally viable manner.

### CROSS-REFERENCE TO RELATED APPLICATIONS

This application claims the benefit of and priority to U.S. Provisional Patent Applications (1) 61/355,990 filed on Jun. 17, 2010 and naming inventors Youngs and Cook, and (2) 61/355,969 filed on Jun. 17, 2010 and naming inventors Youngs and Cook; the contents of both Applications are incorporated by reference as if fully reproduced below.

### BACKGROUND

Collecting matter in a medium, e.g. water in algae, is an expensive process which usually either damages the matter structurally or contaminates the matter so as to make the matter less usable for downstream commercial products, e.g. biofuels, pharmaceuticals, nutraceuticals, and cosmetics. Information relevant to attempts to address these problems can be found in the following: (1) U.S. Pat. No. 6,572,770; (2) US U.S. Pat. No. 5,715,774; (3) US 2010/0105125; (4) US 2010/0210003; (5) US 2011/0016773; (6) US 2009/0203115; (7) US 2010/0144017; (8) US 2010/0267122; (9) US 2011/0065165; (10) EP 942,646; (11) WO 2011038413; (12) WO 9851627; (13) US 20100105125; (14) WO 2010151887; (15) U.S. Pat. No. 3,917,528; (16) U.S. Pat. No. 4,172,039; (17) U.S. Pat. No. 5,259,958; (18) U.S. Pat. No. 6,732,499; (19) U.S. Pat. No. 6,572,770; (20) U.S. Pat. No. 6,393,812; and, (21) The Basics of Oil Spill Cleanup by Mery Fingas, ISBN 9781566705370, CRC Press, Sep. 28 2000. The listing of the preceding documents is in no way an admission of the documents as prior art against the present invention or even as analogous art. The citation of any publication is for its disclosure prior to the filing date and should not be construed as an admission that the present invention is not entitled to antedate such publication by virtue of prior disclosure and/or prior invention.

Each one of the listed documents, and the disclosed methods and apparatuses therein, suffers from one or more of the following disadvantages: (1) they require the use of expensive chemicals; (2) they require the use of chemicals which contaminate collected matter; (3) they require the use of high-energy machines; (4) they require the use of expensive machines; (5) they compromise the collected matter's structural and/or chemical integrity; (6) they require constant supervision by an operator; (7) they require continued replacement of collection and/or concentration parts; (8) they have a high initial capital cost barrier, and thus a disincentive, for market entry; and, (9) they raise the cost of downstream products and processes. Examples of methods and apparatuses which suffer from these disadvantages comprise centrifuges, hollow fiber filtration, cross flow filtration, tangential flow filtration, bubbling, flocculating and porous filters.

Extracting a suspended solid from a liquid medium using the known prior art methods and apparatuses is an expensive process that makes an entire industry of collection and concentration economically and environmentally unsound. Discovering a low cost and environmentally friendly solution to collecting and/or concentrating, e.g., algae in water could allow entire industries that derive, inter alia, biofuels, pharmaceuticals, nutraceuticals and cosmetics from harvested algae to become economically viable, and leaders of those industries can begin to fuel, feed and heal a twenty first century population. A device as described in the following detailed description provides advantages over the known attempts.

### SUMMARY

The present invention is directed to a system that satisfies this need of a low initial, operating and downstream cost while being a contaminant free and a non-damaging system for collecting matter suspended and/or dissolved in a liquid medium. This and other unmet advantages are provided by the device and method described and shown in more detail below.

### BRIEF DESCRIPTION OF THE DRAWINGS

A better understanding of the disclosed embodiments will be obtained from a reading of the following detailed description and the accompanying drawings wherein identical reference characters refer to identical parts:

FIG. 1 is prospective view of a system for collecting matter;

FIG. 2 is prospective view of a system for collecting matter comprising a moving mechanism;

FIG. 3 is prospective view of material comprising cut fibers and a first surface;

FIG. 4 is prospective view of material comprising looped fibers and a first surface;

FIG. 5 is prospective view of material comprising cut fibers, a second surface and a reinforcing surface;

FIG. 6 is prospective view of material comprising looped fibers, second surface, and reinforcing surface;

FIGS. 7a is a view of cut fibers;

FIGS. 7b is a view of cut fibers;

FIGS. 7c is a view of cut fibers and a first surface;

FIG. 8a is a view of material comprising cut fibers, looped fibers and a first surface;

FIG. 8b is a view of material comprising looped fibers, a second surface and a reinforcement fiber;

FIG. 8c is a zoom view of material comprising looped fibers, a second surface, a first surface and a reinforcement fiber;

FIG. 8d is a zoom view of material comprising looped fibers, a second surface, a first surface and a reinforcement fiber;

FIG. 9a is a view of cut fibers;

FIG. 9b is a view of cut fibers and a first surface;

FIG. 9c is a view of cut fibers and a first surface;

FIG. 10 is a view of geometric shapes which can define a cross section of material;

FIG. 11 is a view of a system for collecting matter comprising a material, an extractor and a moving mechanism;

FIG. 12 is a view of a system for collecting matter comprising a looped portion, an extended portion and a drum roller;

FIG. 13 is a view of a system for collecting matter comprising a sheet;

FIG. 14a is a view of a system for collecting matter comprising a third surface and material in a stack;

FIG. 14b is a view of a system for collecting matter comprising a third surface and material in a stack;

FIG. 15a is a view of material emerging from a medium with collected matter;

FIG. 15b is a view of material emerging from a medium with collected matter;

FIG. 15c is a view of material emerging from a medium with collected matter;

FIG. 16a is a view of algae attached to a fiber;

FIG. 16b is a view of oil among fibers;

FIG. 17 is a view of system for collecting matter comprising an extractor, a tray and a container;

FIG. 18 is a view of system for collecting matter comprising at least one extractor and a container;

FIG. 19 is a view of system for collecting matter comprising an extractor, a material and a container;

FIG. 20 is a view of system for collecting matter comprising an extractor, a material a container and a medium;

FIG. 21 is a view of system for collecting matter comprising a material, a container, a flotation and a basket;

FIG. 22 is a view of system for collecting matter comprising an extractor, a medium, a material and a boat;

FIG. 23 is a view of system for collecting matter comprising an extractor, a medium, a material, a container and a boat;

FIG. 24 is a view of system for collecting matter comprising an extractor, a medium, a material, a container and a boat;

FIG. 25 is a view of system for collecting matter comprising an extractor, a medium, a material, a container, a raft, an energy converter and a dewatering unit;

FIG. 26 is a view of a system for collecting matter comprising a medium, a material and a boat;

FIG. 27a is a view of a system for collecting matter comprising a cell, a material and a container;

FIG. 27b is a view of a system for collecting matter comprising a cell, a material, an extractor and a container;

FIG. 28a is a view of a system for collecting matter comprising a container, a directional funnel and an extractor; and,

FIG. 28b is a view of a system for collecting matter comprising an extractor.

### DETAILED DESCRIPTION

Prior to describing the various embodiments, the following definitions are provided and should be used unless otherwise indicated.

Definitions

In describing the disclosed subject matter, the following terminology will be used in accordance with the definitions set forth below.

“Comprising” is an open ended transition word that when preceding a list or description the word connotes that the following list or description does not fully list or describe all possibilities; therefore, the list or description can contain additional elements not listed or described.

“Consisting” is a close ended transition word that when preceding a list or description the word connotes that the following list or description is complete.

A “medium” is any environment which is predominantly liquid wherein solids and/or chemicals may exist in the medium in suspension, dispersion or solution. Medium refers to aqueous and non-aqueous mediums equally.

An “aqueous medium” is a medium which is predominantly comprised of liquid water, and the water is at least one selected from the group comprised of fresh water, brackish water, salt water, marine water, briny water, commercial waste water, residential waste water and agricultural waste water. Examples of bodies of aqueous mediums, which can be natural or engineered, include rivers, streams, ponds, lakes, oceans, bays, fjords, retaining ponds, settling ponds, raceways, holding tanks, settling tank, photo bio reactors. A “non-aqueous medium” is predominantly comprised of a non-water liquid, such as oil. A medium can be a combination of aqueous and non-aqueous mediums, i.e. it is difficult to tell what is predominant or localized variations in concentration would lead to differing conclusions.

“Deploying” is the action of introducing a material into a medium. A material that is deployed can be fully or partially submerged in a medium, floating on a surface of a medium, at a boundary of a medium, or combinations thereof.

“Resides” is a point in space where at least a substantial portion of material exists in a medium; therefore, a description of where the material resides is not intended to mean where 100% of the material resides, rather that is the general location where a substantial portion of the material is deployed.

“Matter” is a solid and/or chemical suspended, dispersed or dissolved in a medium. Matter is at least one selected from the group comprised of algae, oil, bacteria, silt, sand, ethane, hexanol, nitrates, phosphates, benzene, lead, mercury, cadmium, iron, aluminum and arsenic.

“Collection” is a capture of matter on a material, as described below. Collection also includes any matter which is captured by, between or proximate to matter already captured by the material. Matter can form multiple layers on the material surface, and any subsequent matter layers are considered to be collected though it may not be touching or interlocked with, or in physical or bonded contact with the material. The process of collection is at least one selected from the group of active collection, passive collection and growth collection. Similar words which are intended to invoke variations of this definition comprise collects, collecting, collected and to collect.

“Collected matter” is any matter that is collected by, between or proximate to a material.

“Active collection” is a process of how a material collects matter, and active collection occurs in two common scenarios: (1) when the material is predominantly collecting matter while in motion relative to the medium and/or matter; (2) when the material is predominantly collecting matter while the medium is forced to pass through, over and/or around the material. An example of (1) is when the material is passed through the medium by active dragging behind a boat or rotating like a conveyor belt. An example of (2) is when the material is fixed in a housing such as inside a medium conduit and the medium is forced by gravity and/or pressure to flow through, over and/or around the material.

“Passive collection” is a process of how a material collects matter, and passive collection occurs when the material is suspended in, placed on a surface or at a boundary of a medium and the matter collects on the material. Passive collection still occurs when there is relative motion between the material and/or the medium and/or the matter; however, that relative motion occurs, e.g., due to wind, currents and/or waves.

The practical difference between active and passive collection is that active collection occurs generally when humans directly or indirectly act to cause the relative motion whereas passive collection occurs generally when natural forces act to cause the relative motion. Additionally, the material can be actively collecting for a period of time and then transition to passive collection for another period of time. Furthermore, the boundary between what is active and passive collection may blur, e.g. when material is placed at an apex of a human made spill way and the medium flows through, over and/or around the material under force of gravity. That could be categorized as partially active and partially passive collection; however, if either passive or active collection is occurring, then the material is being used in accordance with this invention. In conclusion as to this point, active and passive are relative terms which are not intended to be mutually exclusive or absolute; they are only intended to roughly categorize different methods of deploying the material in a medium at any given time.

“Growth collection” is a process by which matter grows on a material, and growth collection occurs when a suspended and/or dissolved solid increases its mass while attached to the material due to metabolic processes. A suspended solid which is capable of growing on the material is algae and other microorganism to form a biofilm. Growth collection can be any proportion or no proportion, in relation to passive and active collection, of the method by which the matter is collected on the material.

“Material” is any three dimensional object, consistent with its description below, that is capable of collecting matter in a medium. “Material” is short for “material for collecting matter”; therefore, a reference to a material is understood to be a material for collecting matter, unless indicated otherwise.

“Deployed material” is material that was introduced into a medium irrespective of whether the material resides at a surface of the medium, a boundary of the medium or is fully or partially submerged in the medium.

An “extractor” is any device, consistent with its description below, that removes collected matter from a material. Examples of an extractor is at least one selected from the group comprising an orifice, a belt roller, a nested roller, a funnel, a vacuum, a scraper, an electric charge, a spinner, a vibrator, a human hand, a heater, a steamer and a low-volume high pressure sprayer. Similar words which are intended to invoke variations of this definition comprise extraction, extracting, to extract and extracts.

“Extracted matter” is any matter that is formerly collected matter due to an extractor or extraction process. The extracted matter will be a combination of formerly suspended and/or dissolved matter and the medium in which the matter was suspended and/or dissolved.

A “container” is any device which is capable retaining or storing, for any amount of time, collected matter while segregating the collected matter from a medium. Examples of containers are barrels, boxes, troughs, hoppers, tubes, pipes, trays, buckets and bladders. The collected matter can flow to the container in any number of ways, including by gravity, by pump, by conveyor, or by another container such as a pipe or bucket.

A “dwell time” or a “dwell period” is a duration that a material spends in a medium, and the material may be motionless or in motion. Collection occurs during the dwell period; however, the material is not necessarily collecting continuously or at a same rate during the dwell period.

A “boat” is any vessel for transport by water, constructed to provide buoyancy by excluding water and shaped to give stability and permit propulsion. A boat also includes any apparatus connected, attached or affixed, permanently or temporarily, to the boat and also including anything towed or transported by the boat such as a raft, dock, platform or flotation.

“Algae” is plural for any organism with chlorophyll and, in multicellular algae, a thallus not differentiated into roots, stems and leaves, and encompasses prokaryotic and eukaryotic organisms that are photoautotrophic or facultative heterotrophs. The term “algae” includes macroalgae (such as seaweed) and microalgae. For certain embodiments of the disclosure, algae that are not macroalgae are preferred. The term algae used interchangeably herein, refers to any microscopic algae, phytoplankton, photoautotrophic or facultative heterotroph protozoa, photoautotrophic or facultative heterotrophic prokaryotes, and cyanobacteria (commonly referred to as blue-green algae and formerly classified as Cyanophyceae). The use of the term “algal” also relates to microalgae and thus encompasses the meaning of “microalgal.” The term “algal composition” refers to any composition that comprises algae, and is not limited to the body of water or the culture in which the algae are cultivated. An algal composition can be an algal culture, a concentrated algal culture, or a dewatered mass of algae, and can be in a liquid, semi-solid, or solid form. A non-liquid algal composition can be described in terms of moisture level or percentage weight of the solids. An “algal culture” is an algal composition that comprises live algae.

The algae of the disclosure can be naturally occurring species, a selected strain, a genetically manipulated strain, a transgenic strain, or a synthetic alga. Algae from tropical, subtropical, temperate, polar or other climatic regions can be used in the disclosure. Endemic or indigenous algal species are generally preferred over introduced species where an open culturing system is used. Algae, including microalgae, inhabit all types of aquatic environments, including but not limited to freshwater (less than about 0.5 parts per thousand (ppt) salts), brackish (about 0.5 to about 31 ppt salts), marine (about 31 to about 38 ppt salts), and briny (greater than about 38 ppt salts). Any of such aquatic environments, freshwater species, marine species, and/or species that thrive in varying and/or intermediate salinities or nutrient levels, can be used in the embodiments of the disclosure.

In certain embodiments, the algal composition of the disclosure comprises green algae from one or more of the following taxonomic classes: Micromonadophyceae, Charophyceae, Ulvophyceae and Chlorophyceae. Non-limiting examples include species of Borodinella, Chlorella (e.g., C. ellipsoidea), Chlamydomonas, Dunaliella (e.g., D. salina, D. bardawil), Franceia, Haematococcus, Oocystis (e.g., O. parva, O. pustilla), Scenedesmus, Stichococcus, Ankistrodesmus (e.g., A. falcatus), Chlorococcum, Monoraphidium, Nannochloris and Botryococcus (e.g., B. braunii). In certain embodiments, the algal composition of the disclosure comprises golden-brown algae from one or more of the following taxonomic classes: Chrysophyceae and Synurophyceae. Non-limiting examples include Boekelovia species (e.g. B. hooglandii) and Ochromonas species. In certain embodiments, the algal composition in the disclosure comprises freshwater, brackish, or marine diatoms from one or more of the following taxonomic classes: Bacillariophyceae, Coscinodiscophyceae, and Fragilariophyceae. The diatoms can be photoautotrophic or auxotrophic. Non-limiting examples include Achnanthes (e.g., .4. orientalis), Amphora (e.g., Acoffeiformis strains, A. delicatissima), Amphiprora (e.g., A. hyaline), Amphipleura, Chaetoceros (e.g., C. muelleri, C. gracilis), Caloneis, Camphylodiscus, Cyclotella (e.g., C. cryptica, C. meneghiniana), Cricosphaera, Cymbella, Diploneis, Entomoneis, Fragilaria, Hantschia, Gyrosigma, Melosira, Navicula (e.g., N. acceptata, N. biskanterae, N. pseudotenelloides, N. saprophila), Nitzschia (e.g., N. dissipata, N. communis, N. inconspicua, N. pusilla strains, N. microcephala, N. intermedia, N. hantzschiana, N. alexandrina, N. quadrangula), Phaeodactylum (e.g., P. tricornutum), Pleurosigma, Pleurochrysis (e.g., P. carterae, P. dentata), Selenastrum, Surirella and Thalassiosira (e.g., T. weissflogii). In certain embodiments, the algal composition of the disclosure comprises one or more algae from the following groups: Coelastrum, Chlorosarcina, Micractinium, Porphyridium, Nostoc, Closterium, Elakatothrix, Cyanosarcina, Trachelamonas, Kirchneriella, Carteria, Crytomonas, Chlamydamonas, Planktothrix, Anabaena, Hymenomonas, lsochrysis, Pavlova, Monodus, Monallanthus, Platymonas, Pyramimonas, Stephanodiscus, Chroococcus, Staurastrum, Netrium, and Tetraselmis, Galdieria and Cyanidium, and any unknown algae having similar genus, family, or orders. In certain embodiments, the algal composition of the disclosure comprises one or more from the following groups: Porphyridium cruentum, Spirulina platensis, Cyclotella nana, Dunaliella salina, Dunaliella bardawil, Muriellopsis spp., Chlorella fusca, Chlorella zofingiensis, Chlorella spp., Haematococcus pluvialis, Chlorococcum citriforme, Neospongiococcum gelatinosum, lsochrysis galbana, Chlorella stigmataphora, Chlorella vulgaris, Chlorella pyrenoidosa, Chlamydomonas mexicana, Scenedesmus obliquus, Scenedesmus braziliensis, Scenedesmus dimorphus, Stichococcus bacillaris, Anabaena flos-aquae, Porphyridium aerugineum, Fragilaria sublinearis, Skeletonema costatum, Pavlova gyrens, Monochrysis lutheri, Coccolithus huxleyi, Nitzschia palea, Dunaliella tertiolecta, Prymnesium paruum, and the like. In certain embodiments, the algal composition of the disclosure comprises one or more from the following groups: N. gaditana, N. granulate, N. limnetica, N. oceanica, N. oculata, N. salina.

Preferred species of algae comprise Scenedesmus dimorphus, Nanochloropsis, Chlorella and diatoms.

### Overview

A system for collecting matter, as described below, provides a low energy, low cost and nearly zero pollutant process for extracting suspended and/or dissolved matter in a medium. The system collects the matter on a material which is deployed into the medium, and the matter is extracted off the material. If the extracted matter is algae, then it can be processed into end user commercial products such as pharmaceuticals, nutraceuticals, cosmetics, biofuels, food products, crop fertilizer, animal feed and polymers. If the extracted matter is oil or bitumen, then it can be recovered at oil spills or in tar sands. If the medium is infected with a harmful algae bloom of cyanobacteria, then the system could not only harvest the algae for processing but also cut off a food source of the algae by additionally extracting suspended silt. This invention collects matter in an economically and environmentally viable manner.

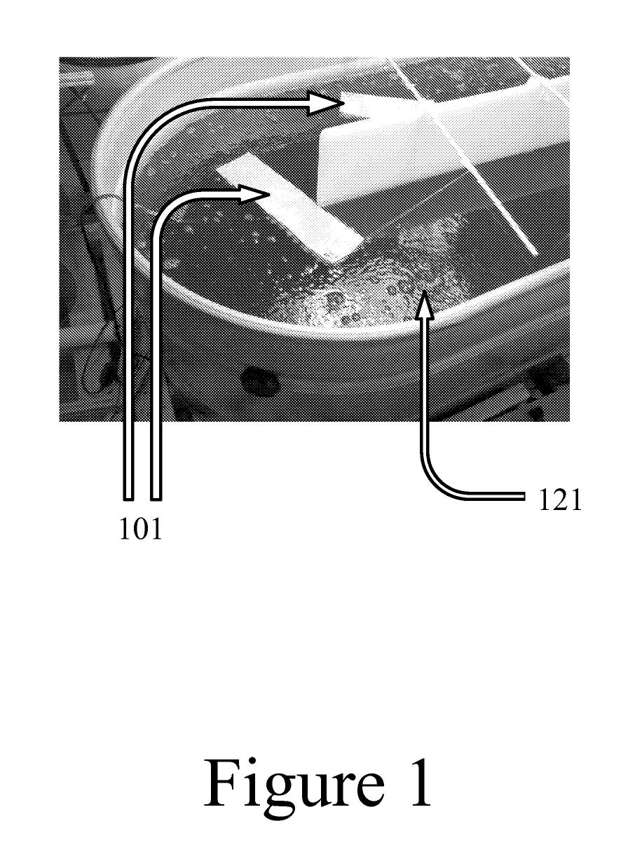

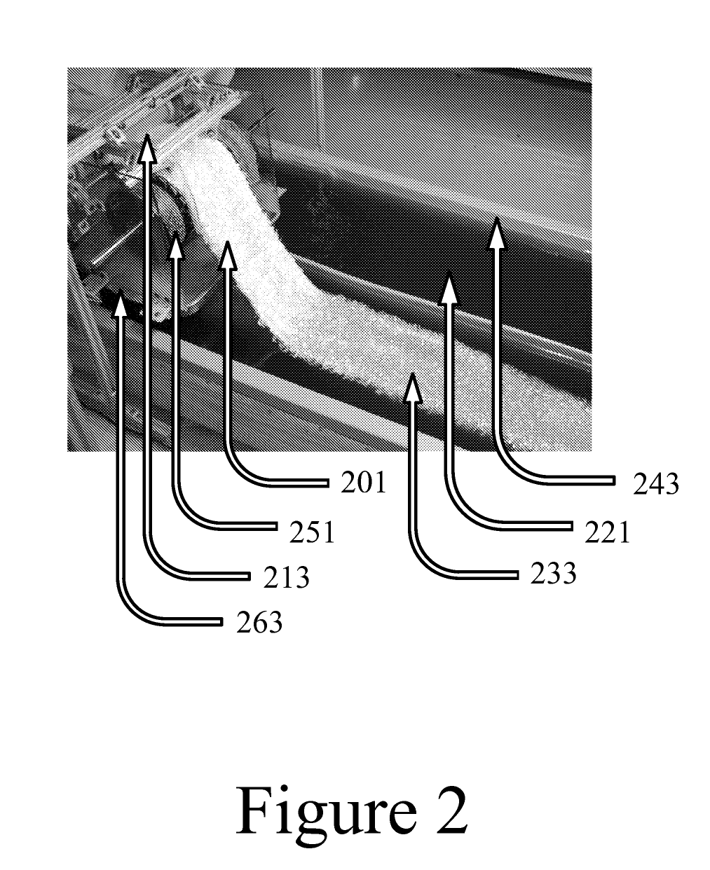

FIGS. 1 and 2 depict embodiments of systems for collecting matter; however, FIGS. 1 and 2 show optional features which are not necessary to practice every embodiment of the invention. These systems for collecting matter were chosen, because a detailed discussion of many possible systems and their individual features is aided by first giving the system context.

As shown in FIG. 1, a system for collecting matter comprises a material 101 for collecting matter (not visible) in a medium 121. Material 101 in FIG. 1 is depicted as two individual and independent portions of material 101. In this embodiment, medium 121 is a fresh water aqueous medium. Collected matter is not visible for reasons discussed below. In FIG. 1, a small pump (not visible) is inducing slight movement of medium 121 in body 143 to simulate natural forces and to make passive collection a dominant collection mechanism. Flow rate through the pump can be increased to convert passive collection to active collection; furthermore, the pump can be turned off to make growth and/or passive collection the dominant collection process.

As shown in FIG. 2, another embodiment of a system for collecting matter comprises material 201 which is deployed in medium 221 which contains matter (not visible). In this embodiment, medium 221 is a fresh water aqueous solution. Material 201 emerges, in part, from medium 221 by rotation of a moving mechanism 251, which is, in this embodiment, a drum shaped device. Material 201 also emerges, in part, from medium 221 by rotation of an extractor. The extractor, in this embodiment, is belt roller 213 which compresses material 201 as it passes between two rollers. The compressive force extracts collected matter 233, and the extracted matter is retained by a container embodied as tray 263. Material 201 is formed into a belt. After a portion of material 201 passes through extractor 213 that same portion is deployed into medium 221 to collect more matter. The rotational motion causes active collection to be a dominant collection mechanism. The rotational motion can be continuous or intermittent or even stopped to promote any one of growth collection, passive collection or active collection.

### Discussion

### Material

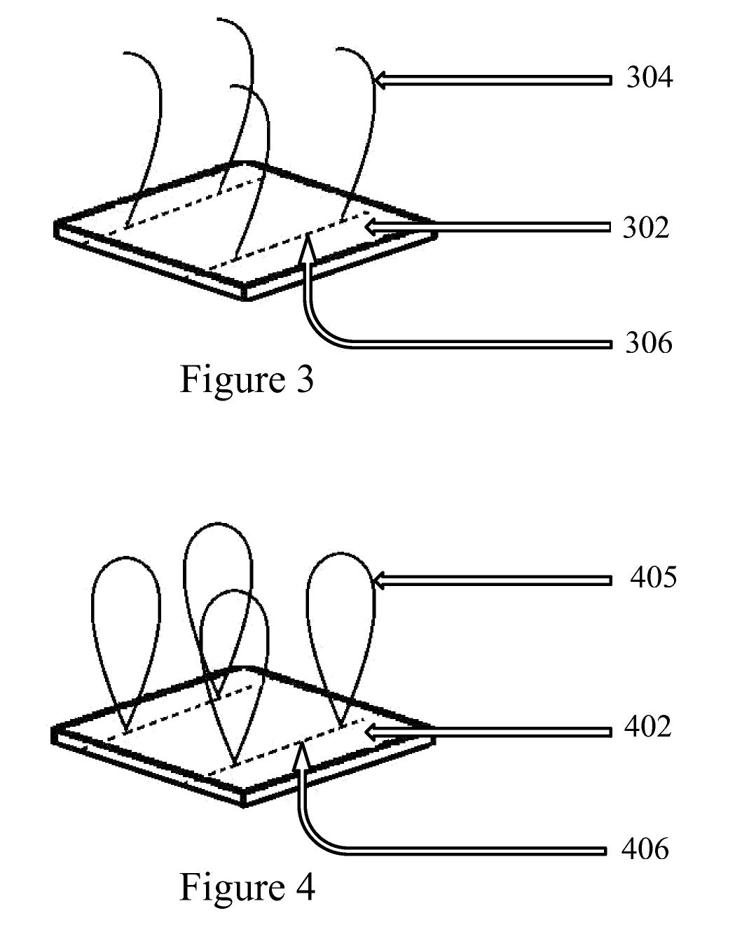

As shown in FIGS. 3 and 4, a material for collecting matter is comprised of at least a first surface 302 or 402 and a fiber. The fiber can be cut fiber 304 which is bound to the first surface 303, or the fiber can be a looped fiber which is bound to the first surface 402. The material can contain a combination of cut fibers 304 and looped fibers 405 which are bound to a common surface such as first surface 302 or 402. Cut fiber 304 and/or looped fiber 405 can be composed of a single filament or multiple filaments spun, twisted, braided or bunched to form substantially a single fiber such as a tuft, yarn, cord or rope.

Cut fiber 304 or looped fiber 405 ranges in length from 0.25″ to 12″ and more. More preferably, cut fiber 304 or looped fiber 405 is between 0.5″ and 3″, and an example preferred length of cut fiber 304 or looped fiber 405 is 1″. Spacing between a base of any two cut fibers 304 can range from 0.01″ to 7″ and more. More preferably, the spacing is 0.025″ to 1″, and an example preferred spacing distance of cut fiber 304 or looped fiber 405 is 0.05″. If cut fiber 304 or looped fiber 405 is a single filament, then the diameter of cut fiber 304 or looped fiber 405 can range from 0.0001 to 0.10″ and more, and an example of a preferred filament diameter of cut fiber 304 or looped fiber 405 is 0.0004″. If cut fiber 304 or looped fiber 405 is multifilament, then the diameter of that cut fiber 304 or looped fiber 405 is 0.005″ to 2″ and more, and an example of a preferred multifilament diameter of cut fiber 304 or looped fiber 405 is 0.15″. It should be noted that even if a multifilament cut fiber 304 or looped fiber 405 is composed of the same number and size individual filaments, cut fiber 304 or looped fiber 405 can have different diameters due to its method of processing, e.g., spinning, twisting or bunching. A bunched multifilament cut fiber 304 or looped fiber 405 would, everything else being equal, likely have more interstitial voids between fibers than twisted and maybe even more than spun and maybe even more than braided.

Cut fiber 304 or looped fiber 405 is constructed from at least one substance selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, Kevlar, polyurethane, olefin, polyactide and carbon fibre, any blend of these and/or any recycled products of these, and cut fiber 304 or looped fiber 405, if multifilament, can be constructed from a blend of any of those listed substances. An example of preferable substances is nylon and polyester. If cut fiber 304 or looped fiber 405 is a natural fiber, then it can be manufactured in any process known in the art, such as by opening, carding, drawing, roving, spinning and/or twisting. If cut fiber 304 or looped fiber 405 is made from synthetic fibers, then it can be manufactured in any process known in the art, such as by extruding or spinning.

Cut fiber 304 or looped fiber 405 can be treated or processed to make it more or less oleophilic, oleophobic, hydrophilic and hydrophobic such as by adding or removing polymers known in the art which have the named properties. Examples of materials which are oleophilic comprise polypropylene, polyester, polyvinycholoride, steel or aluminum. Furthermore, materials with a combination of the listed properties is particularly advantageous if the material is preferential such as if a material is both oleophilic and hydrophilic but more oleophilic than hydrophilic. For example, integrating polyester may increase the oleophilic and hydrophilic nature of cut fiber 304 or looped fiber 405, but the cut fiber 304 or looped fiber 405 will be preferentially oleophilic. Although not intended to be limiting, if polyester material is deployed in an oil and water medium, then oil will dominate as collected matter over water; therefore, oil can be removed from the water and stored without removing the water its environment. This advantage increases recovery rate of, e.g., an oil spill in aqueous medium. Furthermore, this permits the use of the material for tar sand or bitumen recovery after, e.g., water or steam is used to bring oil to the earth's surface. An oleophobic material, such as nylon or cotton, can be used to collect matter in a non-aqueous medium, such as oil, to lower levels of matter in the oil.

Cut fiber 304 or looped fiber 405 can be treated or processed to make it more or less conductive, such as by adding carbon or a polymer. Individual filaments of cut fiber can be processed to have any cross sectional shape from a circle, to a W or S shape, to a triangle, to a square, to a pentagon, to a hexagon, to an octagon, to star shaped. An example preferred embodiment is polyester in a circle or nylon in a W shape. Furthermore, individual filaments of cut fiber can be processed to have any longitudinal shape from a hair, to a W or S shape.

First surface 302 or 402 has a thickness that is seen in FIG. 3 or FIG. 4, respectively, and that thickness can range from 0.01″ to 1.0″ and more. More preferably, first surface 302 has thickness between 0.02″ and 0.5″, and an example preferred thickness of first surface 302 is 0.025″. As the surface area of first surface 302 or 402 increases due to increasing length and/or width of, e.g., a belt of the material, the thickness of first surface 302 or 402 will likely increase to compensate for the increase in tensile forces exhibited during operation of the system for collecting matter. Alternatively, a second surface, as described below, can be attached to the first surface 302 or 402 to reduce strain on the first surface, in whole or in part.

First surface 302 or 402 can be constructed from any process known in the art which would make a planar surface from at least one substance selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, polyurethane, olefin, polyactide, rubber, Kevlar, metallic mesh, carbon fibre, any blend of these and/or recycled products of these. An example of preferable substances is nylon and polyester. First surface 302 or 402 can be manufactured in any process known in the art, such as by weaving, knitting, tufting, spread tow, felting, thermal or mechanical bonding, extrusion, injection molding, compression molding or stamping.

Although the cut fiber 304 and looped fiber 405 are bound to their respective first surfaces, repeated extraction cycles could cause the fibers to disconnect from the first surface 302 or 402, and such disconnection could be detrimental to a material's collection rate. Therefore, the fibers, such as cut fiber 304 and looped fiber 405, can be further secured to the first surface by way of fiber reinforcement 306 or 406. Fiber reinforcement 306 or 406 are represented as dashed lines, because the fiber reinforcement can be integrated into the first surface 302 or 402, respectively, or on a portion of first surface 302 or 402 which is not visible given the particular view. Alternatively, fiber reinforcement 306 or 406 can be attached to the first surface such that cut fiber 304 or looped fiber 405, respectively, not only intersects the first surface and but also is reinforced by fiber reinforcement 306 or 406, respectively, at substantially the same point in space. Said attachment can occur with bonding by welding, adhering, stitching, laminating or any other process known by a person of skill in the art which can bond two or more surfaces together. Fiber reinforcement 306 and 406 can be manufactured from any synthetic or natural fiber which would increase the number of extraction cycles a fiber can endure without disconnecting from the first surface 302 or 402. An example of a preferred embodiment of a fiber reinforcement is a high twist multifilament nylon strand.

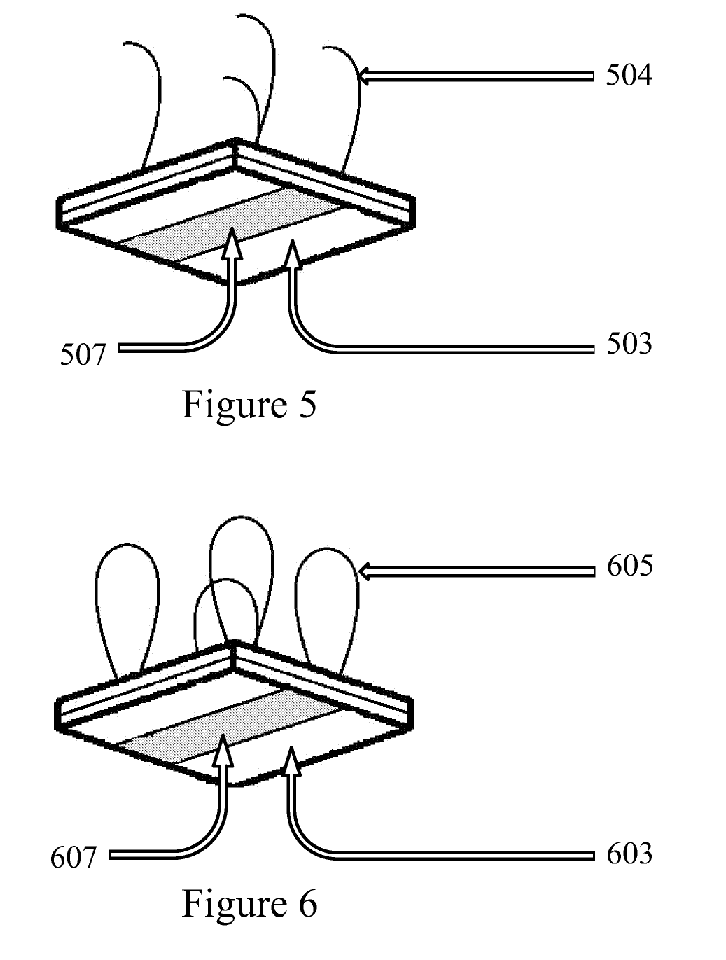

As shown in FIGS. 5 and 6, an example embodiment of a material for collecting matter further comprises a second surface 503 or 603 which is attached to a first surface, such as first surface 302 or 402 in FIGS. 3 and 4, respectively, of the material. Said attachment can occur with bonding by welding, adhering, stitching, laminating or any other process known by a person of skill in the art which can bond two or more surfaces together. Second surface 503 and 603 can provide additional features to the material which may not be provided, in whole or in part, by said first surface. Such additional features comprise improved tensile strength, increased or decreased flexibility or rigidity, increased or decreased coefficient of friction for, e.g., configuring to an extractor or moving mechanism, increased or decreased buoyancy, and/or increased or decreased collection rates. In an example embodiment, a second surface 503 or 603 could be constructed of a foam which may cause, e.g., an increase in buoyancy, a reduction of drag in a medium, a reduction of belt friction on a moving mechanism. In an example embodiment, a second surface 503 or 603 could be another first surface complete with cut fibers and/or looped fibers which may, e.g., cause an increase in collection rate. In an example embodiment, a second surface 503 or 603 could be a polymeric sheet which may cause an increase or decrease in buoyancy depending on density, an increase in rigidity and increase in tensile strength. An example of a preferred embodiment of a second surface is a closed cell polyethylene foam which permits the material to reside at a boundary between a medium and the atmosphere. Another example of a preferred embodiment as a second surface is another first surface with cut fibers and/or looped fibers so as to create a double sided material.

As shown in FIGS. 5 and 6, an example embodiment of a material for collecting matter further comprises a surface reinforcement 507 or 607 attached to a surface of the material. Although the material has high a high tensile strength, repeated extraction cycles could cause a rupture in a surface of the material. Surface reinforcement 507 and 607 are shown as attached to second surface 503 and 603, respectively; however, surface reinforcement 507 and 607 could be attached to a first surface, such as first surface 302 or 402 in FIGS. 3 and 4, respectively, of the material regardless of whether second surface 503 or 603 exist. A surface reinforcement system could integrate into or with a fiber reinforcement system such that reinforcement of a fiber or a surface is achieved using the same reinforcement. Said attachment of the surface reinforcement 507 or 607 to a surface of the material can occur with bonding by welding, adhering, stitching, laminating or any other process known by a person of skill in the art which can bond two or more surfaces together. Surface reinforcement 507 or 607 can be any reinforcement material known to a person of skill in the art which could increase the tensile strength of a surface such as woven nylon, Kevlar sheets, extruded polymers, carbon nanotubes, metallic meshes and many others. An example of a preferred embodiment of surface reinforcement is a nylon seatbelt like material stitched to a distal surface of the material from which cut fibers and or looped fibers protrude, such as is seen in FIGS. 5 and 6.

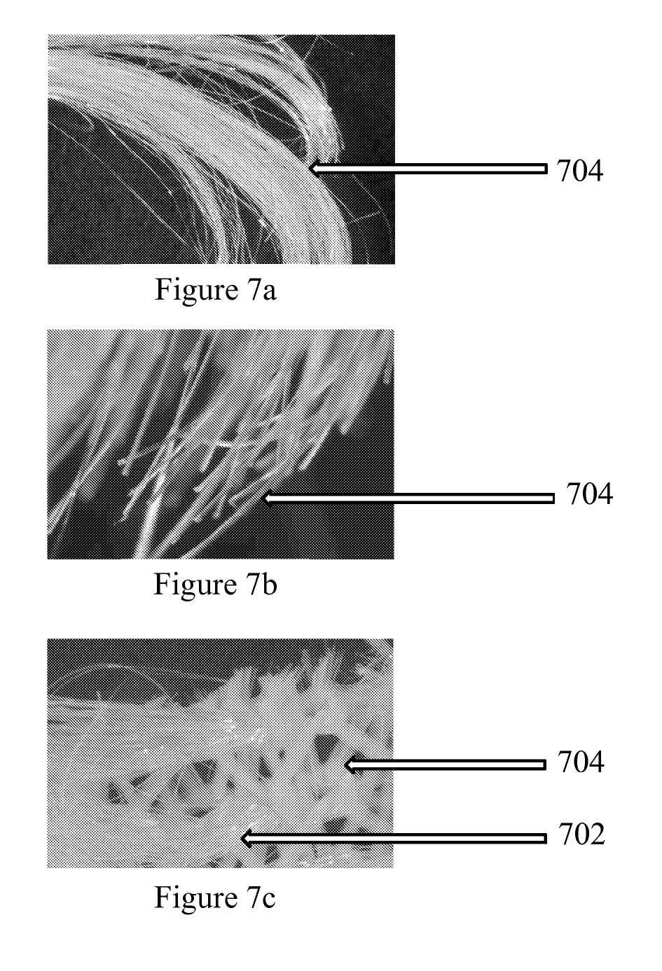

As shown in FIGS. 7a and 7b, an example embodiment of a cut fiber 704 is shown in increasing zoom. In this example embodiment, cut fiber 704 is a multifilament bunched fiber with a substantially circular cross section. FIG. 7C is an example embodiment of the cut fiber 704 and a first surface 702. The first surface 702 is a woven structure composed of multifilament wefts and warps with cut fiber 704 interlaced between said wefts and warps and projecting out from first surface 702.

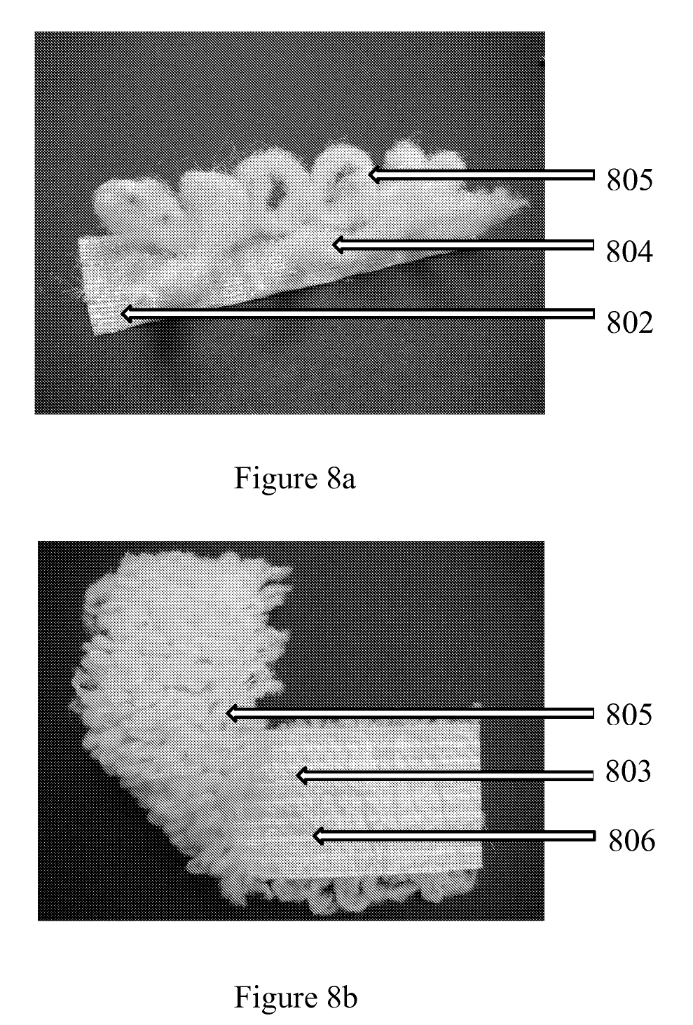

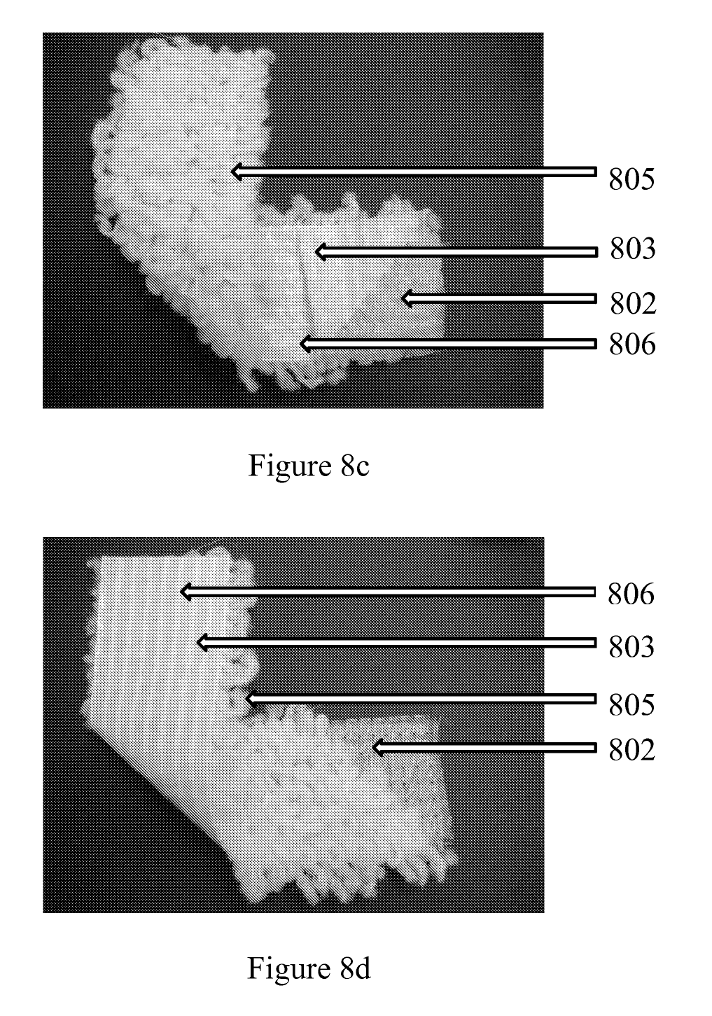

As shown in FIG. 8a, an example embodiment of a material for collecting matter is comprised of a first surface 802, a cut fiber 804 and a looped fiber 805. In this example embodiment, first surface 802 is constructed by weaving nylon straps having a width of 0.05″ and a thickness 0.015″. Cut fiber 804 is a multifilament nylon wind protruding 1.5″ from the first surface, and an approximate diameter of cut fiber 804 is 0.25″. Looped fiber 805 is of the same construction as cut fiber 804, and looped fiber 805 protrudes 0.75″ from first surface 802. An approximate width of looped fiber 805, taking into account a central void formed by the looped fibers, is 0.75″. Spacing between any two cut fibers 804 and/or looped fibers 805 is between 0.5″ and 0.65″.

As shown in FIG. 8b, an example embodiment of a material for collecting matter is comprised of a looped fiber 805, a second surface 803 and a fiber reinforcement 806. Second surface 803 is constructed of a 0.15″ thick nylon sheet bonded to at least a first surface (not visible). Fiber reinforcement 806, which runs the length of the material, is a 0.15″ diameter nylon winding which is connected to looped fiber 805.

As shown in FIGS. 8c and 8d, an example embodiment of a material for collecting matter is comprised of a looped fiber 805, a first surface 802, a second surface 803 and a fiber reinforcement 806.

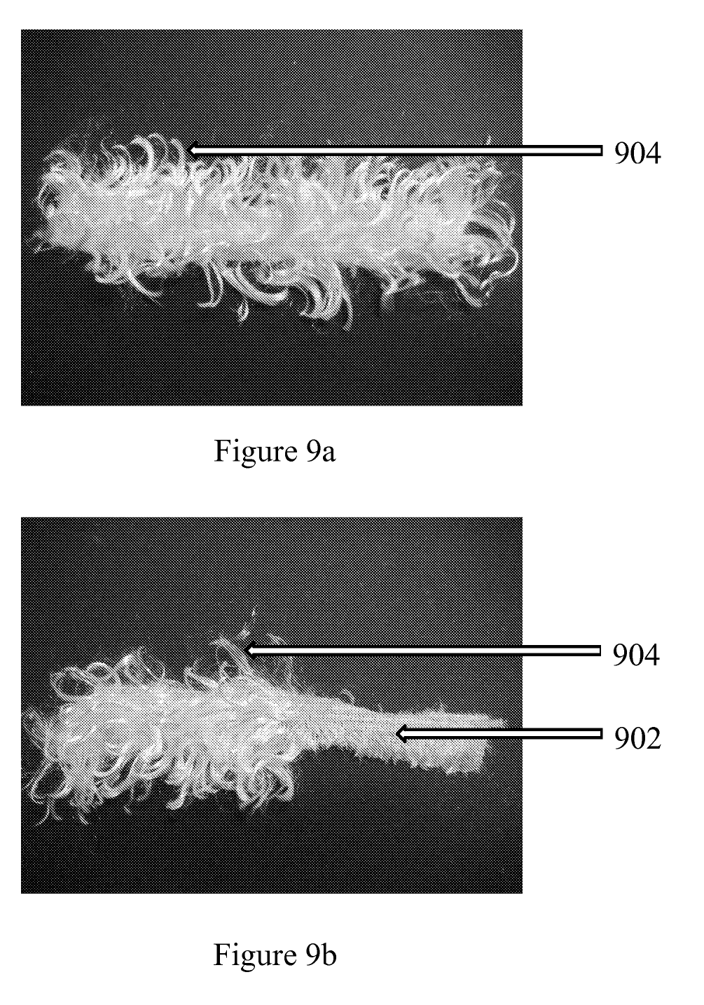

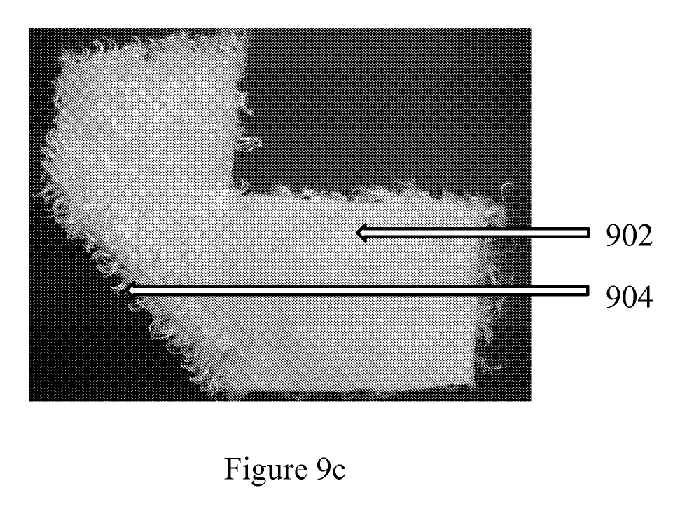

As shown in FIGS. 9a to 9c, an example embodiment of a material for collecting matter is comprised of a first surface 902 and a cut fiber 904. First surface 902 is a polyester weave comprised of a 0.010″ diameter multifilament thread. Cut fiber 904, which is anchored to first surface 902 by woven integration, is a 0.05″ diameter multifilament polyester wind protruding one inch from the first surface 902. Spacing between any two cut fiber 904 ranges between 0.010″ and 0.1″.

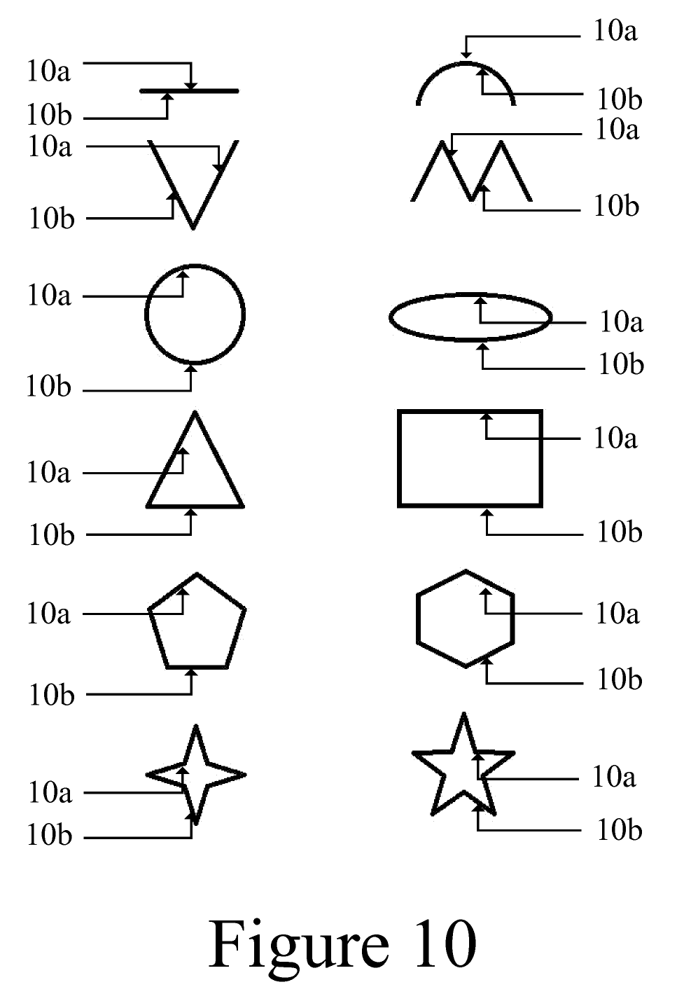

The example embodiments of a material for collecting matter discussed above have all represented the material as substantially planar; however and as shown in FIG. 10, a cross section of the material can take on any geometric shape having surface 10a and surface 10b. Surface 10a can be a first surface, as described above, and surface 10b can be second surface, as described above. Alternatively, surface 10a can be a second surface, and surface 10b can be first surface. Furthermore, surfaces 10a and 10b can have the same or different chemical and/or geometric structure. Surfaces 10a and 10b can be different surfaces of the same three dimensional object; therefore, either 10a and 10b are both a first surface or 10a and 10b are both a second surface.

If the combination of surfaces 10a and 10b form a closed geometric shape, then the internal void defined by the surfaces 10a and 10b can be filled with an object. That object can increase or decrease the buoyancy of the material. For example, a stainless steel cables will decrease the material's buoyancy where as a closed cell polyethylene foam will increase the material's buoyancy. Furthermore, the object can be absorbent such that it will collect matter through absorption in addition to matter collected on material. In an example embodiment, the object is a polypropylene fiber and/or foam and the matter is oil. The closed geometric shape can be formed, e.g., by first taking a planar sheet of material, then folding it over and then joining the edges together. The exact geometric shape of such stitched material takes can be determined by, e.g., the shape of the inserted object. Alternatively, a first or second layer can be processed directly into any geometric shape, open or closed, by any known method in the art, such as stamping, crimping, extruding, injection molding, compression molding. In an example preferred embodiment, surface 10a is a first surface, surface 10b is a second surface. In another example preferred embodiment, a material for collecting matter has a cross sectional geometric shape that is substantially oval.

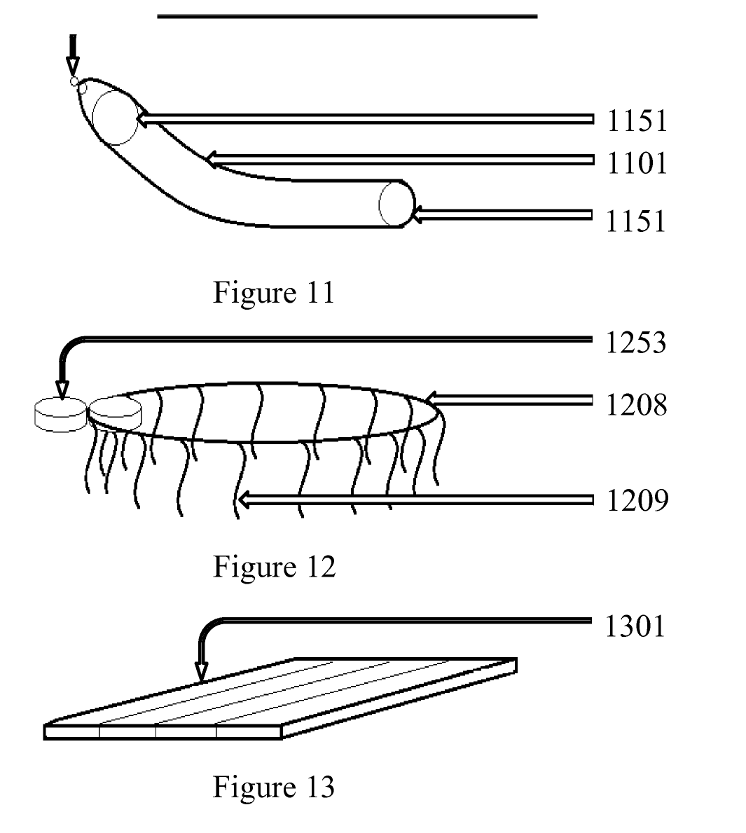

FIGS. 11-13 display diverse embodiments that a material, as described in example embodiments above, can be constructed into. As shown in FIG. 11, an example embodiment of a system for collecting matter is comprised of a material 1101, an extractor 1113 and a moving mechanism 1151. The FIGURE omits a medium for simplicity. Material 1101 is formed into a belt that is looped around moving mechanism 1151 represented by a pair of drums capable of rotation and advancing, in whole or in part, material 1101 through extractor 1111, represented by a pair of rollers which are also capable of rotation and advancing, in whole or in part the material 1101. The belt can range in circumference from 1 to 100 feet; however, the upper boundary of circumference is only limited by tensile strength of the belt and power to the moving mechanism. Therefore, a belt with substantial reinforcements, as described above coupled with a high powered motor driving the moving mechanism can reach circumferences of well over 100 feet to 500 feet and greater.

As shown in FIG. 12, an example embodiment of a system for collecting matter is comprised of a material and a moving mechanism. The FIGURE omits a medium for simplicity. The material is comprised of a hooped portion 1208 with an elongated portion 1209. Hooped portion 1208 and elongated portion 1209 can be formed from the same or different configuration of material, including substance and geometry, as discussed above. The elongated portion 1209 allows the system to increase collection rate by increasing surface area of the material and by probing a portion of the medium not interacted with or by hooped portion 1208. The moving mechanism is comprised of two drum rollers 1253 which simultaneously extract matter from the material and advance the material through the drum rollers 1253. Alternatively, hooped portion 1208 can be severed at any point to create a long rope like structure which can aid in storage or collection of the system seen in FIG. 12. The hooped portion can range in circumference from 1 to 100 feet; however, the upper boundary of circumference is only limited by tensile strength of the hooped portion and power to the moving mechanism. Therefore, a belt with substantial reinforcements, as described above coupled with a high powered motor driving the moving mechanism can reach circumferences of well over 100 feet to 500 feet and greater. The elongated portion can range in length from 6 inches to 50 feet and greater.

As shown in FIG. 13, an example embodiment of a system for collecting matter is comprised of a material 1301, and the material 1301 is formed by attaching several strips of material at their borders to form a larger sheet. The FIGURE omits a medium for simplicity. In an example embodiment, material 1301 can be towed across a medium's surface by boat to actively collect matter, and in another example embodiment, material 1301 can be anchored so that it passively collects matter. Material 1301 can be rolled up for storage purposes, and material 1301 can be deployed into or emerge out of a medium by rolling out or up, respectively. The strips can range in length from 6 inches to 100 feet and greater; however, the upper boundary of length is only limited by tensile strength of the strip. Therefore, a strip with substantial reinforcements can reach well over 100 feet to 500 feet and greater. The strips can range in width from 1 inch to 100 inches and greater, and a sheet can range in width from 2 inches to 50 feet and greater.

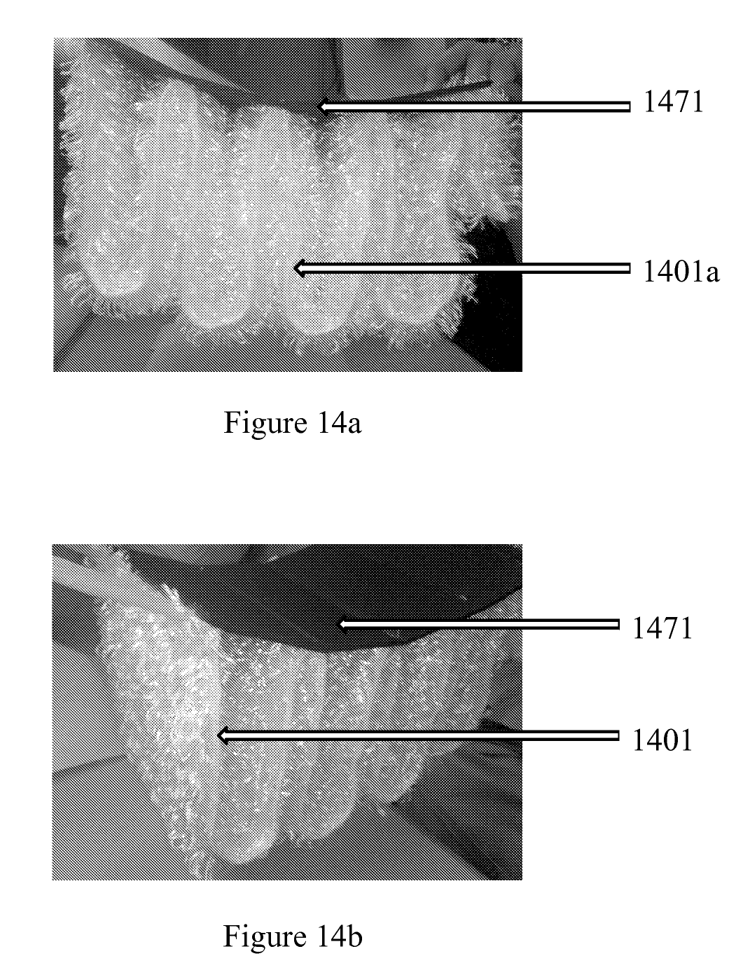

As shown in FIGS. 14a and 14b, an example embodiment of a system for collecting matter is comprised of a material 1401 and a flotation 1471. Material 1401 is first folded in half and then stitched along an edge to form a closed geometric shape. Material 1401 is then attached to third surface 1471 to form a stack configuration. Third surface 1471 can be used to increase or decrease the stack's buoyancy and/or tensile strength, and the third surface 1471 can be constructed of at least one selected from the group of foam, plastic, wood, metal, metal fiber, any fiber material listed above. The stack embodiment increases the surface area per unit volume of material 1401. The stacks can range in length from 6 inches to 100 feet and greater; however, the upper boundary of length is only limited by tensile strength of the third surface 1471. Therefore, a the third surface 1471 with substantial reinforcements can reach well over 100 feet to 300 feet and greater. The stack can range in width from 1 inch to 60 inches and greater, and a sheet, composed of several stacks attached side by side, can range in width from 2 inches to 50 feet and greater.

### Collection

Although not intended to be a limiting statement, the matter may collect on the material by at least one process selected from the group of mechanically, chemically and electrically. A mechanical attraction could be, e.g., that a particle of matter becomes entangled by a fiber. A chemical attraction could be, e.g., that a chemical bond forms between a particle of matter and a fiber. An electrical attraction could be, e.g., that a particle carries an electrical charge which is substantially opposite to a charge present on a fiber's surface. Matter may collect on a material in any combination of the aforementioned processes. Large quantities of matter can collect on material in the same manner as small quantities, but collection rate of matter may increase due to agglomeration of matter which may increase the surface area of the material which allows for more points of collection along the material's surface. Agglomeration could overtake other process of collection as a dominate process.

The process of collecting of matter is aided through material selection when considering to the matter, the medium and the material. In an example embodiment, if a material is constructed of an oleophilic substance and matter to be collected is oil or a lipid containing organism, then the matter will be attracted to and collect on the material. In an example embodiment, if a material is constructed of an oleophilic substance with hydrophobic properties and a material to be collected is oil or a lipid containing organism in an aqueous medium, then the matter will be attracted to and collect on the material preferentially over the aqueous medium. Preferred embodiments of oleophilic and hydrophobic substances include polyester, polyethylene and polypropylene. In another example embodiment, if a material is constructed of a light conducting material and the matter to be collected is attracted to light, then the matter might collect on the material at an increased initial collection rate over non-light conducting material. The increased initial rate could quicken the point at which collection is dominated by agglomeration which will increase overall collection rate. An example embodiment of a light conducting material is an extruded polyester fiber which may conduct a light source's rays/beams which may then attract a photosynthetic organism, such as algae.

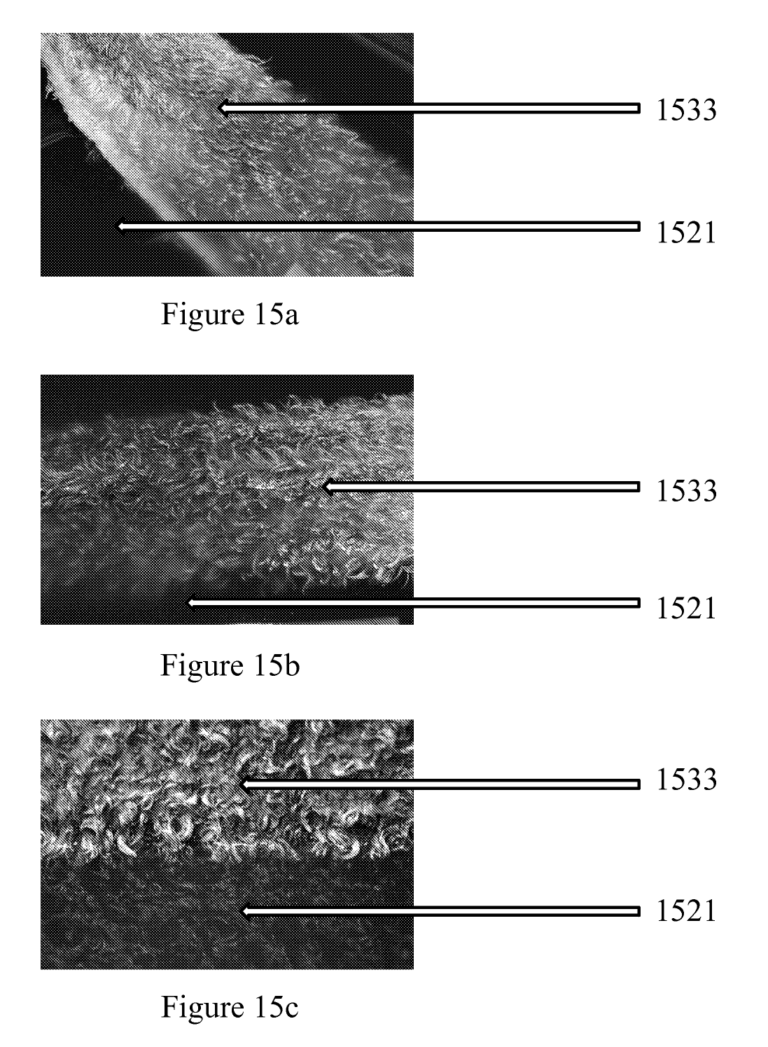

As shown in FIGS. 15a-15c, an example embodiment of a material for collecting matter is comprised of collected matter 1533 which is emerging from a medium 1521. Prior to deployment, the material was white, and the material, as seen prior to extraction, is significantly darkened. The darkening occurs because of the collection of matter in medium 1521. The matter is not visible as individual particles of matter, because, e.g., algae is measured on a micro meter scale. Therefore, a viewer unaided by magnifying technology can only see the matter as a conglomerate of many particles of collected matter 1533 which is represented in FIGS. 15a-15c as dark spots on an otherwise white material.

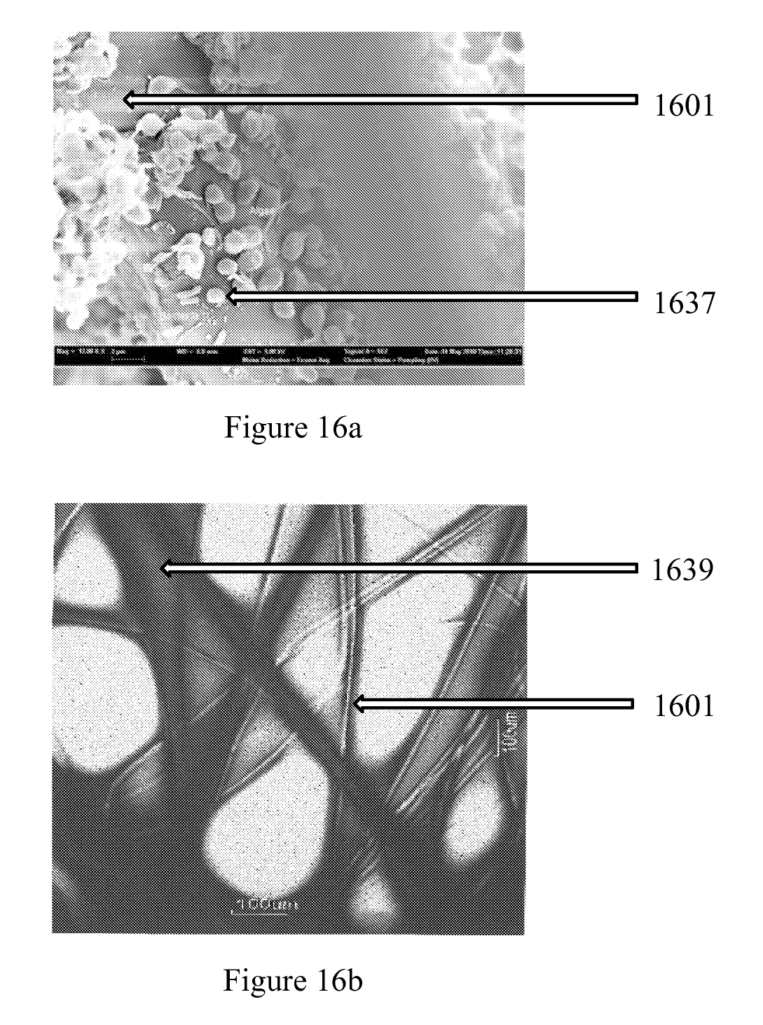

Although the following is not limiting to the invention, a difference can occur in collection between different particles of matter. As seen in FIG. 16a, collected matter 1637, which is algae, is attached to a surface of material 1601. The alga is approximately 2 μm in diameter, and it appears to be a discrete under high zoom. As seen in FIG. 16b, collected matter 1639, which is oil, not only attaches to the material 1601 but also appears to create a continuous membrane which spans the distance between individual fibers of material 1601. The differing phenomenon is only discussed to exhibit visual differences in how matter and material mechanically interact at a micron level.

### Extraction

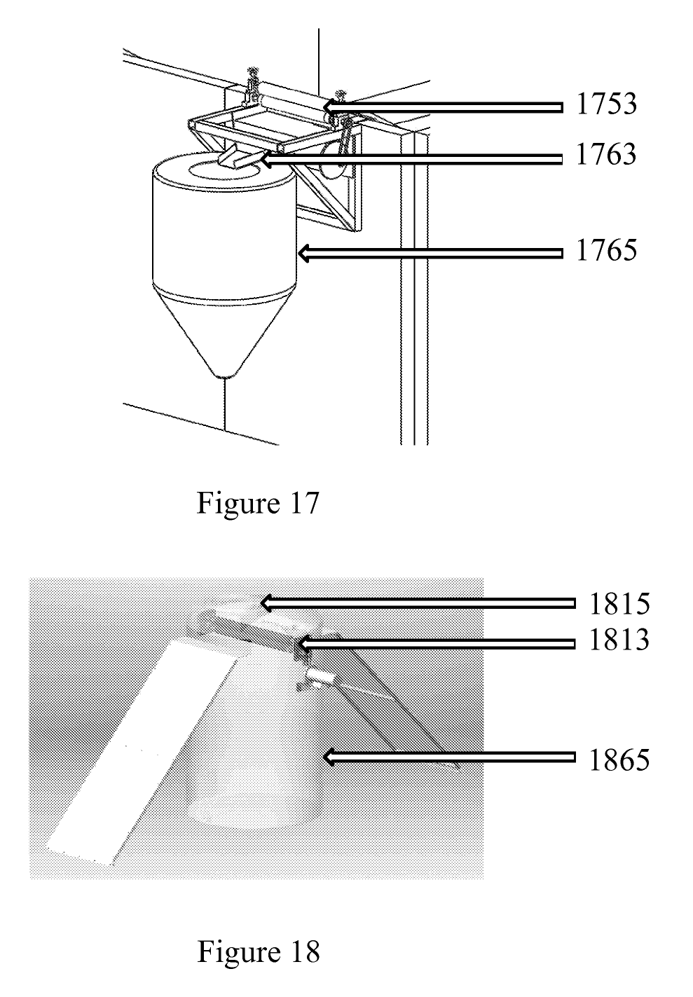

As seen in FIG. 17, an example embodiment for a system for collecting matter is comprised of an extractor, a tray 1763 and a container 1765. The extractor is represented as belt roller 1753 which also combines as a moving mechanism to advance belted material (not visible). Belt roller 1753 applies compressive force to extract collected matter from the belted material. The extracted matter falls under force of gravity into a tray 1763 which funnels the extracted matter into container 1765 for storage.

As seen in FIG. 18, an example embodiment for a system for collecting matter is comprised of an orifice 1815, a belt roller 1813 and a container 1865. Material (not shown) passes through orifice 1815 and into container 1865. Orifice 1815 applies compressive and shear forces to extract collected matter from the material. The material then passes through belt roller 1813 which extracts any remaining matter using compressive forces. Extracted matter from both orifice 1815 and belt roller 1813 fall into container 1865 for storage.

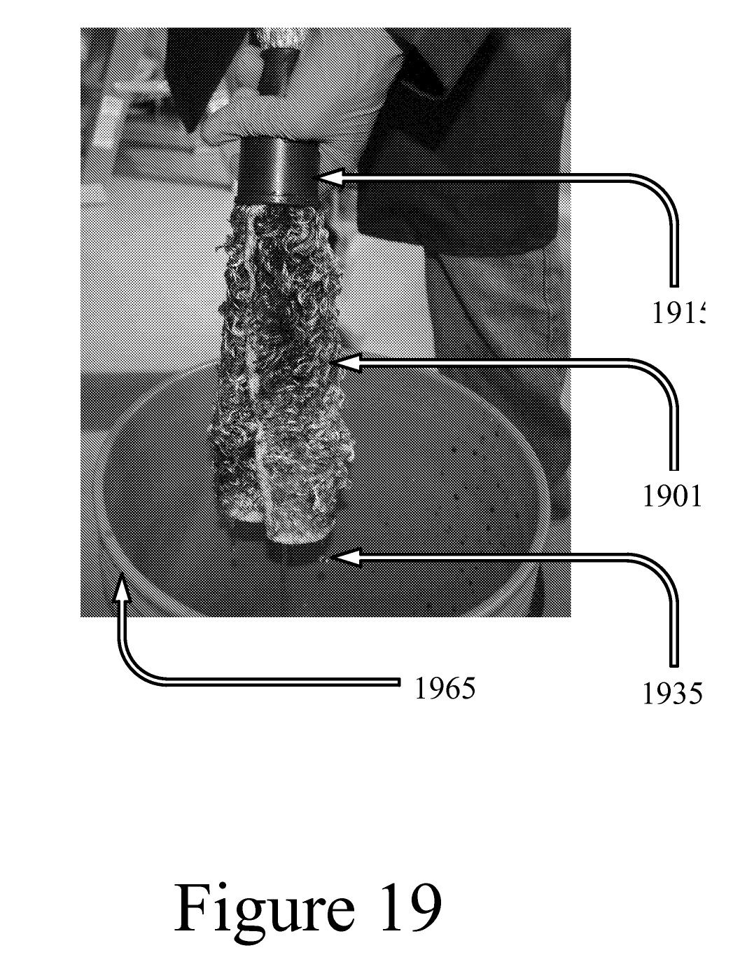

As seen in FIG. 19, an example embodiment for a system for collecting matter is comprised of an orifice 1915, a material 1901 and a container 1965./Material 1901 has emerged from a medium (not shown) and is passing through an orifice 1915 which applies compressive and shear forces to extract extracted matter 1935, seen as a droplet of highly concentrated matter suspended in a medium. The extracted matter 1935 is collected by container 1965.

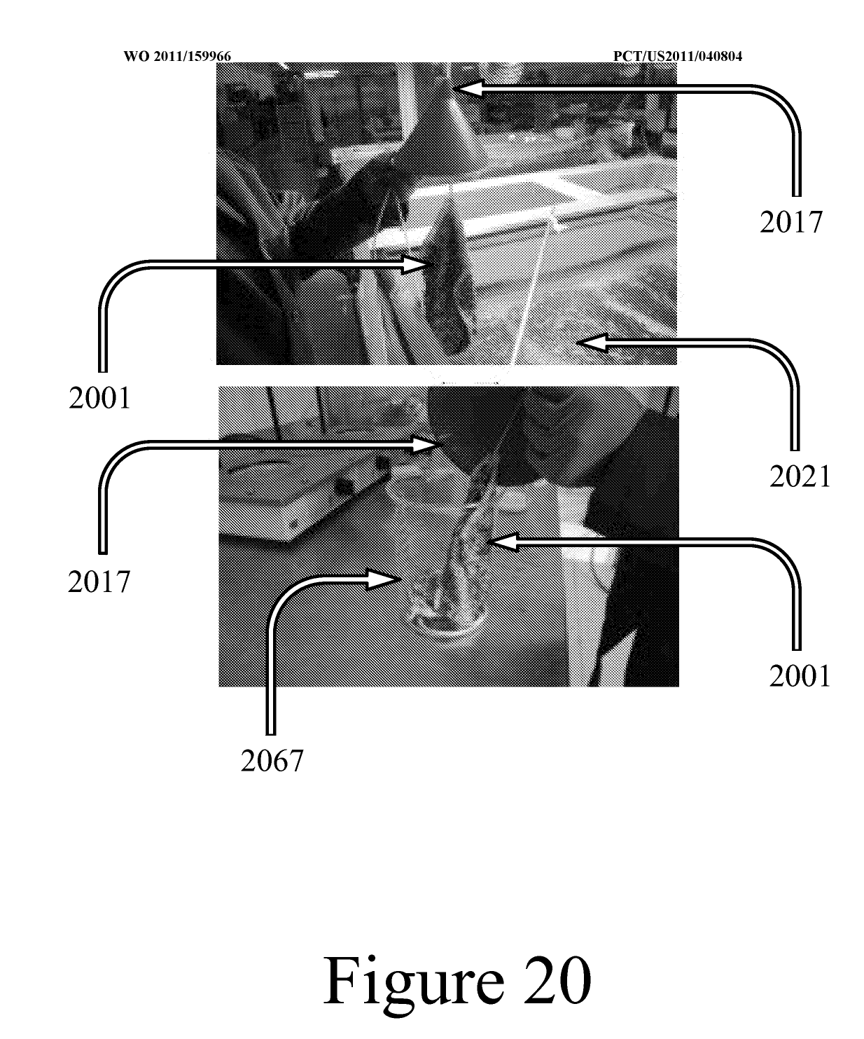

As seen in FIG. 20, an example embodiment for a system for collecting matter is comprised of a funnel 2017, material 2001 and a medium 2021. Extraction of collected matter on the material 2001 occurs by passing material 2001 through funnel 2017. Extracted matter collects in a beaker 2067.

Although not limiting to the invention, an interesting advantage to the current system is what happens to extracted matter as it sits in a container. If a matter is algae and a medium is water, then the algae would be suspended in the water column due to a slight electric charge. After collection and extraction, the material appears to strip the algae of the charge which induces settling inside the container. In one example, algae can settle to the bottom of the container in ten minutes at a quantity which could take several days to achieve by trying have algae settle that is suspended in a water column. If extracted matter, while in a container, settles to the container's bottom, then the remaining water can be used to rinse a portion of material to further aid in extraction. This rinsing, or any other rinsing, can include a high pressure low volume sprayer. This effect is another advantage which permits the current system to reduce costs associated with creating an end user commercial product from algae.

Although not limiting to the invention, it is believed that a majority of collected matter collects on material by mechanical processes; therefore, mechanical extraction—by using a roller or an orifice, or by spinning or vibrating the material, or by using compressed air or water jet to blow or a vacuum to suck off matter—appears to extract a large proportion of collected matter. (A high pressure, low volume water sprayer could also be used to remove the algae. Other means, however, can be used to extract collected matter, such as inducing a charge in the material to cause the material and the matter to repel each other. That charge can, e.g., be applied directly such as by creating a voltage potential, or the charge can occur at the molecular level using substances which create their own charges under specific situations such as exposure to oxygen, chemicals or UV light. Another possible method is through agitation of the material to induce extraction which does not necessarily require contact between the material and a physical device, such as a roller or orifice. Another possible method is through sonication which directs high energy sound waves to extract collected matter. Another possible methods is through extraction using a human hand by forming an orifice with curled fingers.

### Systems and Environments

Systems for collecting matter not previously discussed are detailed in this section.

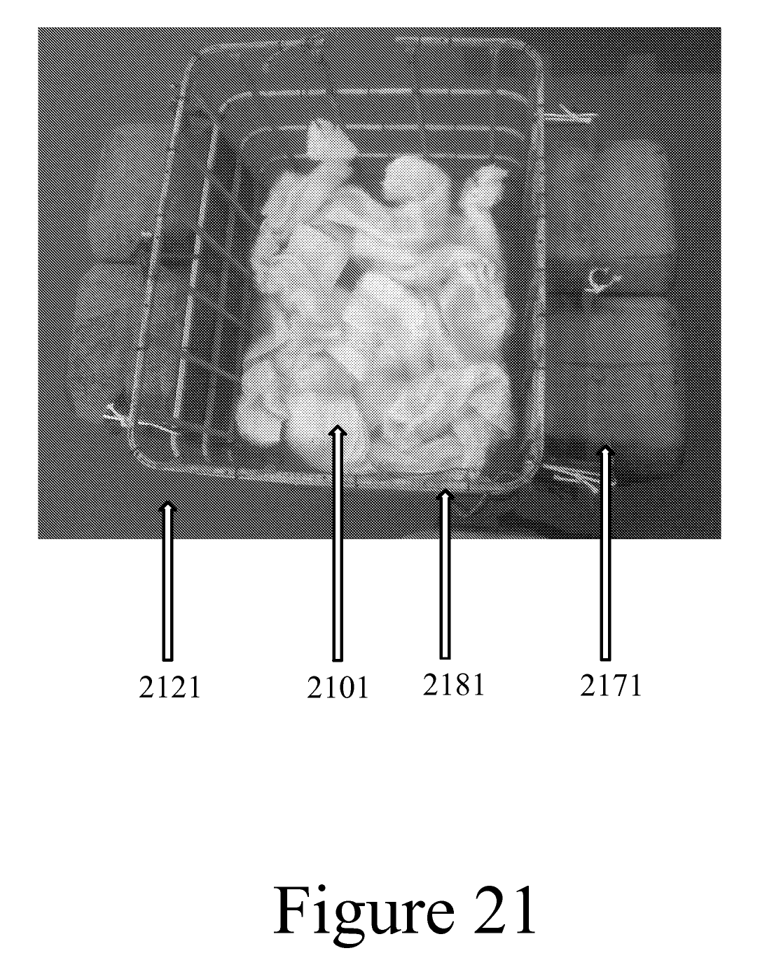

As seen in FIG. 21, an example embodiment of a system for collecting matter is comprised of medium 2121, material 2101, flotation 2171 and basket 2181. Material 2101 is formed into a single long strip which is placed into basket 2181, and basket 2181 is able to float on a surface of medium 2121 by attaching flotation 2171 to the basket 2181. Suspended matter (not visible) is suspended in medium 2121, and the suspended matter passively collects on material 2101.

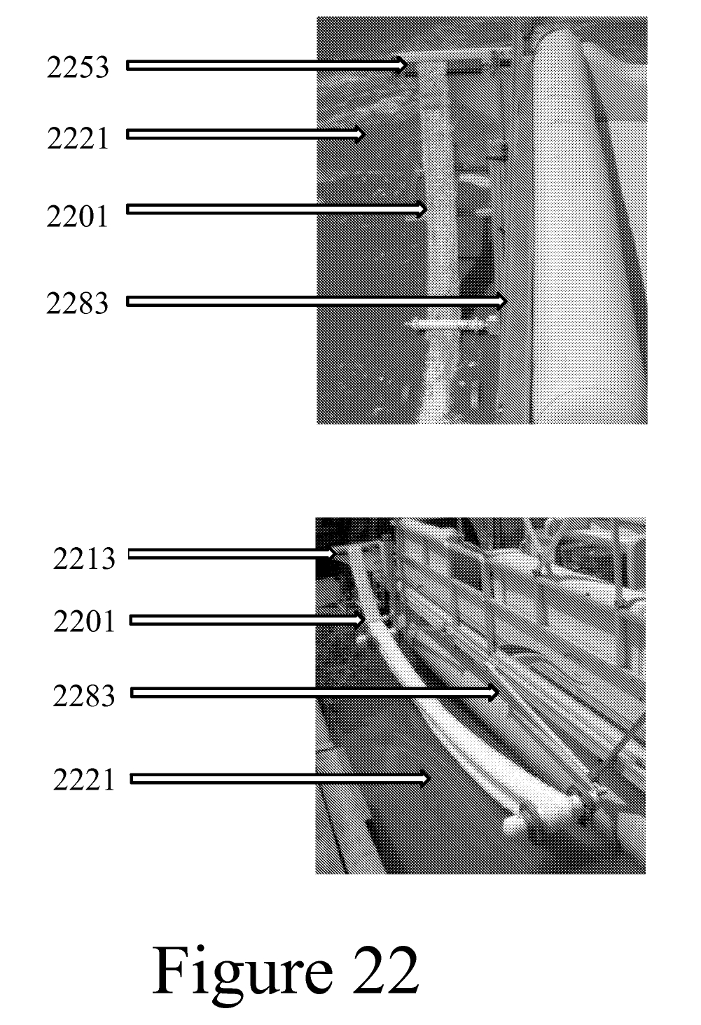

As seen in FIG. 22, another example embodiment of a system for collecting matter is comprised of medium 2221, material 2201, a belt roller 2213 and a boat 2283. Material 2201 is constructed into a belt and affixed to a side of boat 2283 floating an a surface of medium 2221. Material 2201 is deployed in medium 2221, and it advances through belt roller 2213, which extracts actively collected matter that darkened material 2201 in the top picture in FIG. 22.

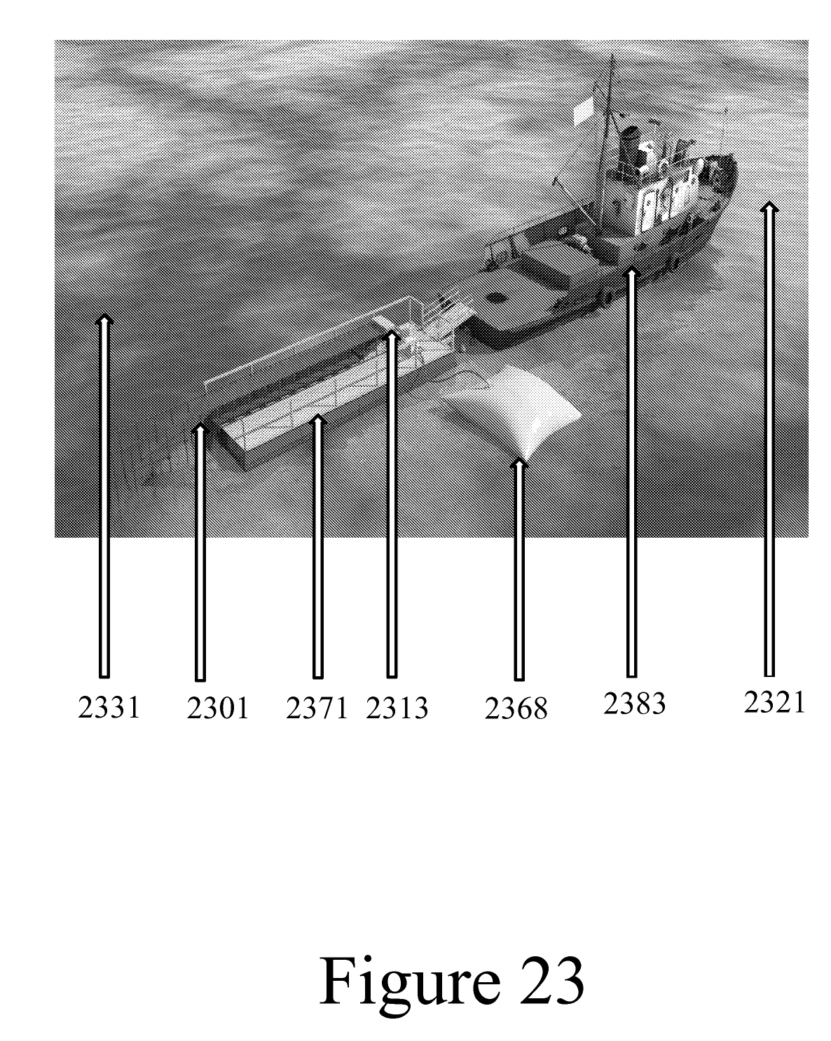

As seen in FIG. 23, another example embodiment of a system for collecting matter is comprised of suspended matter 2331, material 2301, flotation 2373, extractor 2313, boat 2383, medium 2321 and bladder 2368. Suspended matter 2331, which is oil, has darkened medium 2321. Material 2301 submerges into medium 2321 to collect suspended matter 2331, and material 2301 emerges from medium 2321 to advance towards extractor 2313 to extract collected matter. Extracted matter is collected on flotation 2373, which pumps collected matter to bladder 2368, and flotation 2373 and/or bladder 2369 is towed by boat 2383. Material 2301 advances by a moving mechanism (not visible); therefore, material 2301 is actively collecting suspended matter 2331.

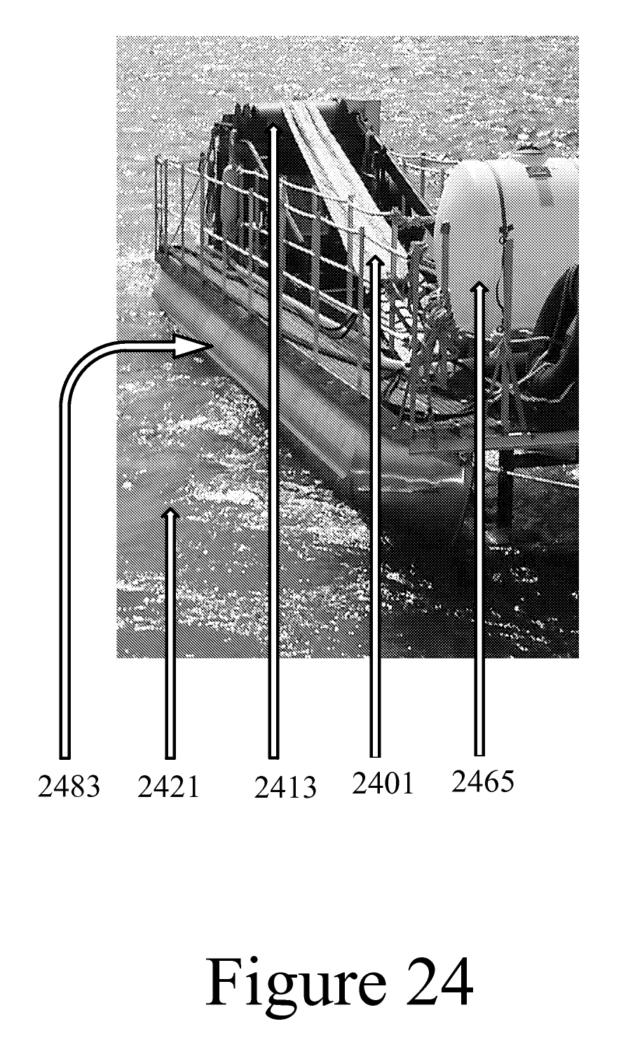

As seen in FIG. 24, another example embodiment of a system for collecting matter is comprised of material 2401, drum 2365, extractor 2413, boat 2483 and medium 2421. Suspended matter is not visible in FIG. 24, but the suspended matter is oil in an aqueous medium. Material 2401 submerges into medium 2421 to collect suspended matter, and material 2401 emerges from medium 2421 to advance towards extractor 2413 to extract collected matter. Extracted matter is collected in drum 2465 which is integrated with boat 2483 as a single matter collecting system. Material 2401 advances by a moving mechanism (not visible); therefore, material 2401 is actively collecting suspended matter.

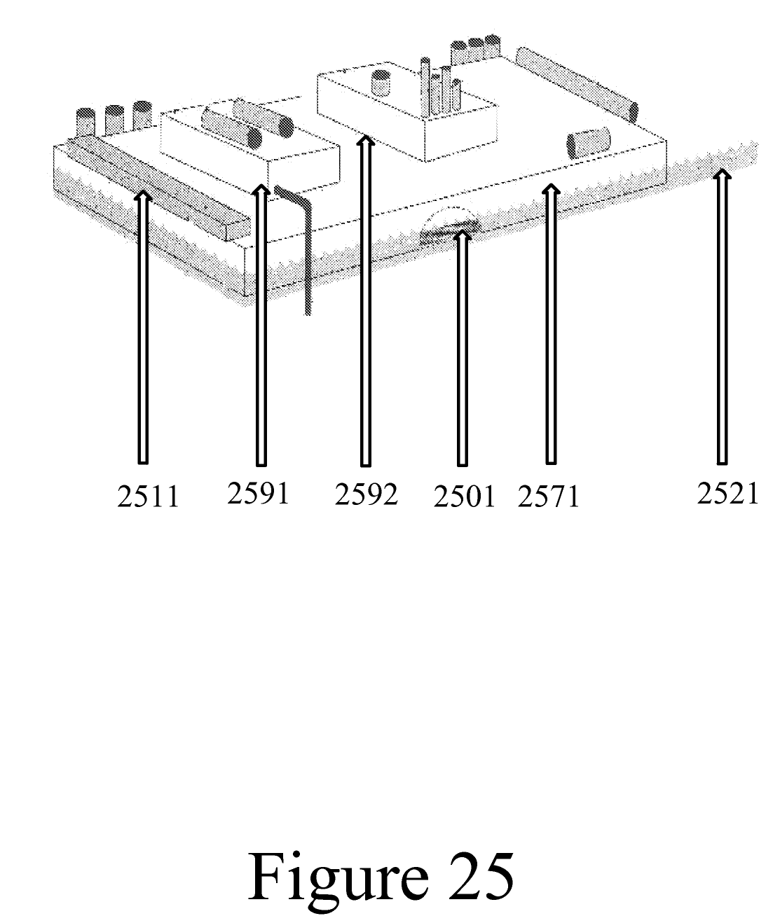

As seen in FIG. 25, another example embodiment of a system for collecting matter is comprised of material 2501, medium 2521, flotation 2571, extractor 2511, dewatering unit 2591 and energy converter 2592. Material 2501 is contained within flotation 2571, as seen in a cutout window, such that material 2501 passively collects suspended solids (not visible) while incorporated amongst flotation 2571 which as at a surface of medium 2521. Material 2501 is advanced to extractor 2511 which can be a combination of at least one extractor, as defined above, to extract collected matter. Extracted matter is transported to dewatering unit 2591, and the dewatered extracted matter can be further processed at energy converter 2592. Energy converter 2592 can contain solar panels to convert the sun's light into electricity to power units such as a moving mechanism, and a dewatering machine. Furthermore, the solar panels can further dry the dewatered extracted matter to use either as another energy source or for storage until the further dewatered extracted matter can be retrieved by an operator. The other energy source can be extracted matter converted into energy by simple incineration, pyrolysis or any other method known in the art. Finally, the solar panels, and or direct solar energy, can be used to distill water that is associated with extracted matter.

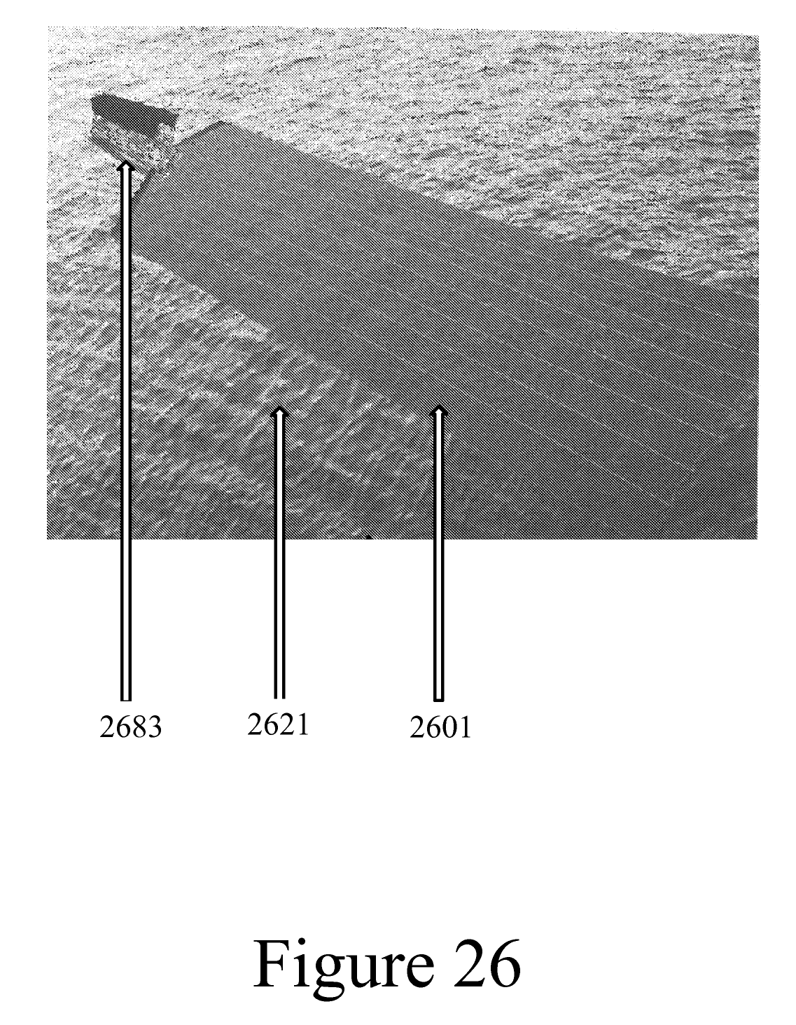

As seen in FIG. 26, another example embodiment of a system for collecting matter is comprised of material 2601, medium 2621 and boat 2683. In this example embodiment, boat 2683 can tow material 2601 to a location on medium 2621, which can be any open body of water. Material 2601 and/or boat 2683 can be anchored so that material 2601 can passively collect suspended matter in medium 2621. If material 2601 is anchored, then boat 2683, can, e.g., return to shore to tow out another sheet of material 2601. Alternatively, boat 2683 can drag material 2601 over or partially submerged in medium 2621 to actively collect suspended matter.

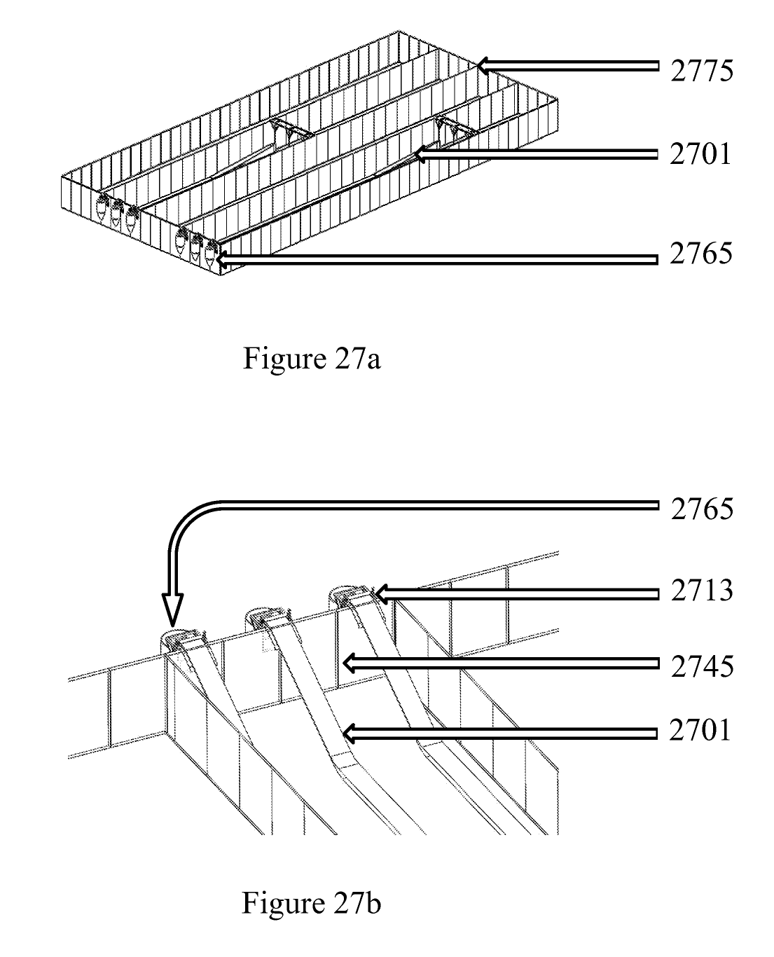

As seen in FIG. 27, another example embodiment of a system for collecting matter is comprised of material 2701, body 2745, container 2765 and belt roller 2713. A medium (not shown) would fill up body 2745 in the same way water fills a swimming pool. Material 2701 is deployed in the type of collection that can occur is at least one selected from the group of growth collection, actively collection and passive collection. If growth collection is desired, then material 2701 is deployed in a medium with a low concentration of suspended matter, e.g. algae, that passively collects on material 2701 while the material 2701 is stagnant or moving slowly. The collected matter grows into a colony of algae and then material 2701 advances towards belt roller 2713 to extract the growth collected material to be stored in container 2765. Alternatively, material 2701 is deployed in a medium with a high concentration of suspended matter, e.g. algae, that passively collects on material 2701 if rotated slowly or if stagnant. After the algae collects, the material advances towards belt roller 2713 to extract the passively collected material which is stored in container 2765. Alternatively, material 2701 is deployed in a medium with a high concentration of suspended matter, e.g. algae, and the material is deployed and quickly rotated through the medium so that the algae passively collects on material 2701. After the algae collects, the material advances towards belt roller 2713 to extract the actively collected material to be stored in container 2765. Alternatively, the suspended matter could be tar sands, bitumen or oil. A body 2745 can range in length from 5 to 500 feet and greater, and body 2745 can range in width from 2 to 100 feet and greater. The length and width of the collection cell is limited only by available floor space; therefore, the length and width are non-limiting example sizes.

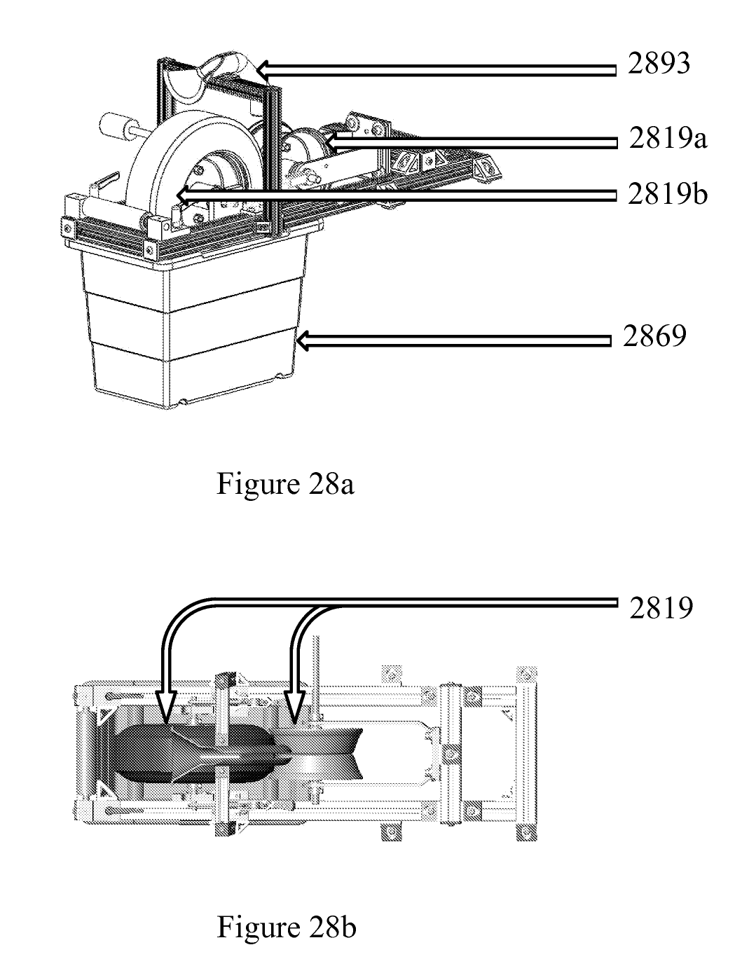

As seen in FIGS. 28a and 28b, an example embodiment of a system for collecting matter comprising a bucket 2869, a pair of nested rollers 2819a and 2819b and a directional funnel 2893. Material (not shown) passes over a first nested roller 2819a and into directional funnel 2893. A purpose of the directional funnel 2893 is to direct the material between nested rollers 2819a and 2819b. First nested roller 2819a and second nested roller 2819b apply compressive force in over a shaped portion of material, as is seen best in FIG. 28b. First nested roller 2819a and second nested roller 2819b can be any shape which compliments a geometric shape of the material, as discussed above. In this example embodiment, extracted matter is collected by an optional bucket 2869.

### Example Tests

### Example 1

A swatch of material 9.84″×39.37″ was cut from cut fiber material made from polyester. The material had a first surface with a thickness of 0.010″. The cut fibers were multifilament bunches having an individual filament diameter of approximately 0.0005″ and a bunch diameter of approximately 0.03″. Spacing between the bunches ranged from 0.05″ to 0.12″. The swatch was folded over into a double sided material and stitched along an edge. Algae were suspended in fresh water medium in a concentration average of 0.056 g/L. Three such swatches were deployed into the medium to passively collect algae for 24 hours. The algae were then extracted from the swatches to form a high concentration extracted algae water mix. The average concentration of the extracted algae water mix was 8.55 g/L which is a concentration increase of 15,267% over the medium's concentration of algae.

### Example 2

A swatch of material 3.93″×15.74″ was cut from looped fiber material made from nylon. The material had a first surface with a thickness of 0.014″. The looped fibers were multifilament winds having an individual filament diameter of approximately 0.003″ and a bunch diameter ranging from 0.25″ to 0.70″. Spacing between the bunches ranged from 0.4″ to 0.65″. Algae were suspended in fresh water medium in a concentration average of 0.1 g/L. Two such swatches were deployed into the medium to passively collect algae for 3 hours. The algae were then extracted from the swatches to form a high concentration extracted algae water mix. The average concentration of the extracted algae water mix was 1.92 g/L which is a concentration increase of 1920% over the medium's concentration of algae.

### Example 3

If a medium has a concentration of matter at 0.5 g/L, then the medium-matter composition is 99.95% medium and 0.05% matter or 1999:1. Obtaining one ton of matter from the medium requires processing nearly 2000 tons of water which is approximately 64,000 cubic feet of water. If extracted matter is 16 g/L, then the medium-matter composition is 98.4% medium and 1.6% matter or only 61.5:1. Obtaining one ton of matter from the extracted matter only requires processing 61.5 tons of water or only 1968 cubic feet of water.

The previously described embodiments of the present invention have many advantages, including systems that satisfy the need for a low initial, operating and downstream cost while being a contaminant free and a non-damaging system for collecting matter suspended and/or dissolved in a liquid medium. Embodiments of the invention do not need to incorporate all advantages that the invention achieves over prior art.

Having shown and described embodiments of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A system for collecting matter, the system comprising
a) a material for collecting matter wherein the material has at least
i. a first surface and
ii. a fiber,
b) a medium, and
c) matter.

2. The system for collecting matter of claim 1, wherein the material is constructed from at least one substance selected from the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, polyurethane, olefin, polyactide and carbon fibre.

3. The system for collecting matter of claim 1, wherein the material is at least one shape selected from the group comprising a single strip, a belt, a sheet, a hooped portion and an elongated portion, and a stack.

4. The system for collecting matter of claim 1, wherein the fiber is at least one selected from the group comprising a cut fiber and a looped fiber.

5. The system for collecting matter of claim 1, further including at least one shape selected from the group comprising a second surface, a reinforcement fiber and a surface reinforcement.

6. The system for collecting matter of claim 1, wherein the medium is at least one selected from the group comprising fresh water, brackish water, salt water, marine water, briny water, commercial waste water, residential waste water and agricultural waste water.

7. The system for collecting matter of claim 1, wherein the matter is at least one selected from the group comprising algae, bacteria, ethane, hexanol, nitrates, phosphates, benzene, lead, mercury, cadmium, iron, aluminum and arsenic.

8. The system for collecting matter of claim 1, further comprising an extractor, wherein the extractor is at least one selected from the group comprising an orifice, a belt roller, a funnel, a vacuum, a scraper, a nested roller, an electric charge, a spinner, a vibrator, a human hand, a heater, a steamer and a low-volume high pressure sprayer.

9. The system for collecting matter of claim 1, further comprising a container wherein the container is at least one selected from the group comprising a barrel, a box, a trough, a hopper, a tube, a pipe, a tray, a bucket and a bladder.

10. The system for collecting matter of claim 1, further including a boat, wherein the boat has at least one selected from the group comprising the material, a container and an extractor.

11. A method of collecting matter, the method comprising
a) supplying a material for collecting matter, wherein the material has at least
i. a first surface and
ii. a fiber,
b) deploying the material in a medium with matter, and
c) collecting matter on the material,

12. The method of collecting matter of claim 11, wherein the method of collection is at least one selected from the group comprising active collection, passive collection and growth collection.

13. The method of collecting matter of claim 11, wherein the method of collection is at least one selected from the group comprising active collection and passive collection.

14. The method of collecting matter of claim 11, wherein the material is selected from at least one of the group comprising polystyrene, polyester, polyamide, polypropylene, polyethylene, vinyl, rayon, cotton, hemp, wool, silk, polyolefins, acrylic, nylon, flax, jute, glass, pina, coir, straw, bamboo, velvet, felt, lyocell, spandex, polyurethane, olefin, polyactide and carbon fibre.

15. The method of collecting matter of claim 11, wherein the material is formed into at least one shape selected from the group comprising a single strip, a belt, a sheet, a hooped portion and an elongated portion, and a stack.

16. The method of collecting matter of claim 11, wherein the fiber is constructed from at least one selected from the group comprising a cut fiber and a looped fiber.

17. The method of collecting matter of claim 11, wherein the material is formed into at least one shape selected from the group comprising a second surface, a reinforcement fiber and a surface reinforcement.

18. The method of collecting matter of claim 11, wherein the medium is at least one selected from the group comprising fresh water, brackish water, salt water, marine water, briny water, commercial waste water, residential waste water and agricultural waste water.

19. The method of collecting matter of claim 11, wherein the matter is at least one selected from the group comprising algae, oil, bacteria, silt, sand, ethane, hexanol, nitrates, phosphates, benzene, lead, mercury, cadmium, iron, aluminum and arsenic.

20. The method of collecting matter of claim 11, further comprising configuring an extractor to operate with the material, wherein the extractor is at least one selected from the group comprising an orifice, a belt roller, a funnel, a vacuum, a scraper, a nested roller, an electric charge, a spinner, a human hand, a heater, a steamer, a low-volume high pressure sprayer and a vibrator.

21. The method of collecting matter of claim 18, further comprising extracting collected matter from the material with an extractor.

22. The method of collecting matter of claim 11, further comprising configuring a container to retain collected matter, wherein the container is at least one selected from the group comprising a barrel, a box, a trough, a hopper, a tube, a pipe, a tray, a bucket and a bladder.

23. The method of collecting and extracting matter of claim 11, further including supplying a boat for transporting at least one selected from the group comprising the material, a container and an extractor.
